(19) United States
(12) Patent Application Publication
(10) Pub. No.: US 2026/0252027 A1
(43) Pub. Date: Aug. 27, 2026

(54) ELECTRONIC APPARATUS, IMAGE FORMING APPARATUS, ATTACHMENT-DETACHMENT DEVICE, AND FIXING DEVICE

(71) Applicant: Oki Electric Industry Co., Ltd., Tokyo (JP)

(72) Inventor: Yoshitaka YANAI, Tokyo (JP)

(73) Assignee: Oki Electric Industry Co., Ltd., Tokyo (JP)

(21) Appl. No.: 19/451,974

(22) Filed: Jan. 16, 2026

(30) Foreign Application Priority Data
Feb. 27, 2025 (JP) 2025-030050

(51) Int. Cl. G03G 21/16; G03G 15/00; G03G 15/20

(52) U.S. Cl. CPC G03G 21/1647; G03G 15/2017; G03G 15/2064; G03G 15/80; G03G 2221/1654

(57) ABSTRACT

A first to-be-engaged portion includes a first region through which a first engagement portion passes in a state where a first connector and a second connector do not engage with each other and are apart from each other during an attachment of an attachment-detachment device to an apparatus main body, and a second region through which the first engagement portion passes after at least a part of the first connector and at least a part of the second connector engage with each other during the attachment of the attachment-detachment device to the apparatus main body. A movable range of the first engagement portion with respect to the first to-be-engaged portion in a direction perpendicular to the attachment direction is larger when the first engagement portion passes through the first region than when the first engagement portion passes through the second region.

### BACKGROUND OF THE INVENTION

### 1. Field of the Invention

The present disclosure relates to an electronic apparatus, an image forming apparatus, an attachment-detachment device, and a fixing device.

### 2. Description of the Related Art

There are known an attachment-detachment device which is attachable to and detachable from an apparatus main body, and an electronic apparatus having such an attachment-detachment device (see, for example, Japanese Laid-open Patent Publication No. 2022-146028). An example of the attachment-detachment device is a fixing device which is attachable to and detachable from the apparatus main body. An example of the electronic apparatus is an image forming apparatus having the fixing device.

When the attachment-detachment device is attached to the apparatus main body, a second connector provided on the attachment-detachment device approaches and engages with a first connector provided on the apparatus main body. By moving the attachment-detachment device in the attachment direction, the first connector and the second connector are electrically connected.

However, in the conventional art, there is a case where the first connector and the second connector may not be appropriately connected when the attachment-detachment device is attached to the apparatus main body.

The present disclosure is made in consideration of the above-described problem, and an object of the present disclosure is to provide an electronic apparatus, an image forming apparatus, an attachment-detachment device, and a fixing device capable of facilitating appropriate connection of the connectors.

### SUMMARY OF THE INVENTION

In order to achieve the above-described object, an electronic apparatus of the present disclosure includes an apparatus main body having a first connector, an attachment-detachment device which is attachable to and detachable from the apparatus main body, a first engagement portion provided on at least one end side of both end sides of one of the apparatus main body and the attachment-detachment device in a crossing direction crossing an attachment direction, and a first to-be-engaged portion provided in the other of the apparatus main body and the attachment-detachment device. The first to-be-engaged portion is engageable with the first engagement portion. The attachment-detachment device includes a second connector which is connectable with the first connector of the apparatus main body by approaching and engaging with the first connector during an attachment of the attachment-detachment device to the apparatus main body. The first to-be-engaged portion includes a first region through which the first engagement portion passes in a state where the first connector and the second connector do not engage with each other and are apart from each other during the attachment of the attachment-detachment device to the apparatus main body, and a second region through which the first engagement portion passes after at least a part of the first connector and at least a part of the second connector engage with each other during the attachment of the attachment-detachment device to the apparatus main body. A movable range of the first engagement portion with respect to the first to-be-engaged portion in the crossing direction is larger when the first engagement portion passes through the second region than when the first engagement portion passes through the first region.

Moreover, an image forming apparatus of the present disclosure includes the above-described electronic apparatus. The attachment-detachment device is a fixing device.

Further, an attachment-detachment device of the present disclosure is attachable to and detachable from an apparatus main body having a first connector. The attachment-detachment device includes a first to-be-engaged portion provided on at least one end side of both end sides of the attachment-detachment device in a crossing direction crossing an attachment direction, the first to-be-engaged portion being engageable with a first engagement portion provided in the apparatus main body, and a second connector which is connectable with the first connector of the apparatus main body by approaching and engaging with the first connector during an attachment of the attachment-detachment device to the apparatus main body. The first to-be-engaged portion includes a first region through which the first engagement portion passes in a state where the first connector and the second connector do not engage with each other and are apart from each other during the attachment of the attachment-detachment device to the apparatus main body, and a second region through which the first engagement portion passes after at least a part of the first connector and at least a part of the second connector engage with each other during the attachment of the attachment-detachment device to the apparatus main body. A movable range of the first engagement portion with respect to the first to-be-engaged portion in the crossing direction is larger when the first engagement portion passes through the second region than when the first engagement portion passes through the first region.

Further, an attachment-detachment device of the present disclosure is attachable to and detachable from an apparatus main body having a first connector. The attachment-detachment device includes a second connector which is connectable with the first connector of the apparatus main body by approaching and engaging with the first connector during an attachment of the attachment-detachment device to the apparatus main body, and a guide portion extending in an attachment direction of the attachment-detachment device and guiding the attachment- detachment device which is attached. The guide portion has a first area, a second area, a third area and a fourth area which are arranged in this order from an upstream side in the attachment direction. In a crossing direction crossing the attachment direction, a width of the first area is wider than a width of the second area, and a width of the third area is wider than a width of the fourth area.

Further, a fixing device of the present disclosure includes the above-described attachment-detachment device. The fixing device includes a heating portion and a pressurizing portion.

According to the present disclosure, in a state where the second connector of the attachment-detachment device is apart from the first connector of the apparatus main body during the attachment of the attachment-detachment device to the apparatus main body, the first engagement portion passes through the first region (i.e., second area) to thereby restrict displacement and inclination of the attachment-detachment device, by which the second connector can be accurately guided to the first connector. After at least a part of the second connector engages with at least a part of the first connector (i.e., after the second connector starts engaging with the first connector), the first engagement portion passes through the second region (i.e., first area), by which the first connector and the second connector can be easily brought into engagement with each other while absorbing misalignment of the connectors due to manufacturing errors of the connectors.

According to the present disclosure, the electronic apparatus, the image forming apparatus, the attachment-detachment device, and the fixing device capable of facilitating appropriate connection of the connectors can be achieved.

### BRIEF DESCRIPTION OF THE DRAWINGS

FIG. 1 is a sectional view showing a configuration of a printing mechanism of an image forming apparatus of a first embodiment.

FIG. 2 is a perspective view showing an external configuration (1) of a fixing device of the first embodiment.

FIG. 3 is a perspective view showing an external configuration (2) of the fixing device of the first embodiment.

FIG. 4 is a perspective view showing an external configuration (3) of the fixing device of the first embodiment.

FIG. 5 is a plan view showing an external configuration (1) of a fixing device attachment portion of the first embodiment.

FIG. 6 is a plan view showing an external configuration (2) of the fixing device attachment portion of the first embodiment.

FIGS. 7A, 7B and 7C are a left-side view, a front view and a right-side view showing a state of attachment (1) of the fixing device of the first embodiment.

FIGS. 8A, 8B and 8C are a left-side view, a front view and a right-side view showing a state of attachment (2) of the fixing device of the first embodiment.

FIGS. 9A, 9B and 9C are a left-side view, a front view and a right-side view showing a state of attachment (3) of the fixing device of the first embodiment.

FIGS. 10A, 10B and 10C are a left-side view, a front view and a right-side view showing a state of attachment (4) of the fixing device of the first embodiment.

FIG. 11 is an enlarged sectional view showing an attachment portion of drawer connectors of the first embodiment.

FIGS. 12A, 12B and 12C are perspective views showing states of connection between the drawer connectors of the first embodiment.

FIG. 13 is a perspective view showing an external configuration of a fixing device of a second embodiment.

FIG. 14 is a plan view showing an external configuration of a fixing device attachment portion of the second embodiment.

FIGS. 15A and 15B are side views showing states of attachment of the fixing device of the second embodiment.

FIG. 16 is a perspective view showing an external configuration of a fixing device of a third embodiment.

FIG. 17 is a plan view showing an external configuration (1) of a fixing device attachment portion of the third embodiment.

FIG. 18 is a plan view showing an external configuration (2) of the fixing device attachment portion of the third embodiment.

FIGS. 19A and 19B are sectional views showing states of attachment of the fixing device of the third embodiment.

FIG. 20 is a perspective view showing an external configuration (1) of a fixing device of in a first modification.

FIG. 21 is a perspective view showing an external configuration (2) of the fixing device in the first modification.

FIG. 22 is a perspective view showing an external configuration of a fixing device attachment portion in the first modification.

FIGS. 23A and 23B are side views showing a configuration in which a fixing device is attached in a lateral direction in a second modification.

Hereinafter, embodiments of the present disclosure will be described with reference to the attached figures.

### 1. FIRST EMBODIMENT

### 1-1. Configuration of Printing Mechanism of Image Forming Apparatus

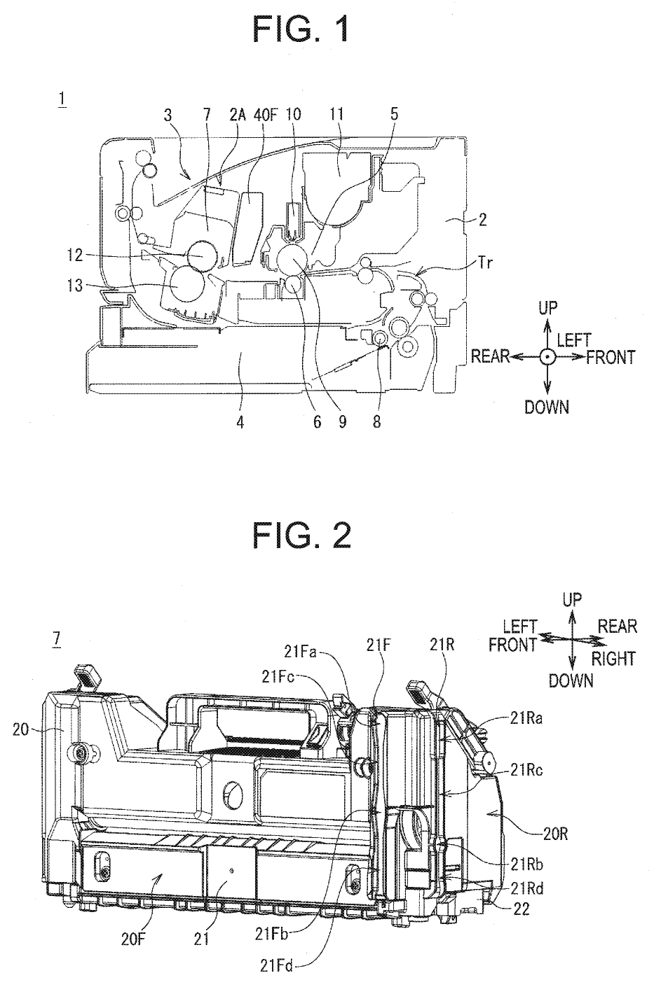

FIG. 1 shows a configuration of a printing mechanism of an image forming apparatus 1 of the first embodiment. The image forming apparatus 1 is an electrophotographic printer, and includes a printing mechanism in a box-shaped apparatus main body 2. The printing mechanism is configured to perform printing on a recording medium such as a printing sheet using a developer such as a toner. Hereinafer, a right side, a left side, a near side, a far side, an upper side and a lower side of the apparatus main body 2 in FIG. 1 will be respectively referred to as a front side, a rear side, a left side, a right side, an upper side and a lower side of the image forming apparatus 1.

A stacker 3 is provided on a top face of the apparatus main body 2. The recording medium on which printing is performed by the image forming apparatus 1 is ejected, and is placed on the stacker 3. A sheet cassette 4 which stores recording media is provided in a lower part in the apparatus main body 2. A transport path Tr is formed in the apparatus main body 2. The transport path Tr extends from the sheet cassette 4 to the stacker 3, and serves as a path for the recording medium.

In the apparatus main body 2, a developing device (image forming unit) 5 and a transfer roller 6, and a fixing device (fuser) 7 are arranged along the transport path Tr in this order from an upstream side in a transport direction (that is, direction from the sheet cassette 4 toward the stacker 3). In the apparatus main body 2, rollers of various types are provided for transporting the recording medium along the transport path Tr.

The sheet cassette 4 is configured to store the recording media, and includes a hopping roller 8 which draws out the stored recording medium to the transport path Tr. The recording medium drawn out from the sheet cassette 4 to the transport path Tr is transported along the transport path Tr to the developing device 5 and the transfer roller 6.

The developing device 5 includes a photosensitive drum 9 as an image bearing body. The photosensitive drum 9 includes a conductive support and a photoconductive layer formed thereon. The transfer roller 6 is provided below the photosensitive drum 9 via the transport path Tr. An LED head 10 serving as an exposure device is provided above the photosensitive drum 9. A developer storage body 11 is attached to the developing device 5. The developer storage body 11 is attachable to and detachable from a main body of the developing device 5. That is, the developer storage body 11 is exchangeable.

The LED head 10 emits light to expose a surface of the photosensitive drum 9 based on printing data. With the exposure, an electrostatic latent image is formed on the surface of the photosensitive drum 9. The developing device 5 develops the electrostatic latent image formed on the surface of the photosensitive drum 9 using a developer (toner) supplied from the developer storage body 11, so that a developer image is formed on the surface of the photosensitive drum 9.

The transfer roller 6 transfers the developer image formed on the surface of the photosensitive drum 9 to the recording medium, when the recording medium passes through between the photosensitive drum 9 and the transfer roller 6.

The fixing device 7 includes a heating roller 12 serving as a heating portion and a pressure roller 13 serving as a pressurizing portion. The heating roller 12 and the pressure roller 13 transport the recording medium while nipping the recording medium at a nip portion therebetween, and fix the developer image (having been transferred to the recording medium) to the recording medium by applying heat and pressure. The recording medium to which the developer image is fixed by the fixing device 7 is ejected, and is placed on to the stacker 3.

The fixing device 7 is attachable to and detachable from the apparatus main body 2. To be more specific, the fixing device 7 can be detached from the apparatus main body 2 by opening a top cover of the apparatus main body 2 and pulling the fixing device 7 upward from a fixing device attachment portion 2A in the apparatus main body 2. The fixing device 7 can be attached to the apparatus main body 2 by opening the top cover of the apparatus main body 2 and inserting the fixing device 7 into the fixing device attachment portion 2A through an upper part of the fixing device attachment portion 2A. Detailed description of an attachment of the fixing device 7 will be made later.

In this regard, as shown in FIG. 1, the fixing device 7 is attached to the apparatus main body 2 in such a manner that the fixing device 7 is slightly inclined so that an upper front end of the fixing device 7 is located on the front side with respect to a lower front end of the fixing device 7.

### 1-2. External Configuration of Fixing Device

An external configuration of the fixing device 7 is shown in FIGS. 2, 3, 4, and 7A through 7C. The fixing device 7 includes a housing (referred to as a fixing housing) 20 as an enclosure. The fixing housing 20 has a substantially rectangular parallelepiped shape elongated in a left-right direction (i.e., a longitudinal direction of the fixing hosing 20). The fixing housing 20 has a front face 20F, a left-side face 20L, and a right-side face 20R which constitute a cover front 21. Thus, the front face 20F, the left-side face 20L, and the right-side face 20R of the fixing housing 20 are also referred to as the front face 20F, the left-side face 20L, and the right-side face 20R of the cover front 21.

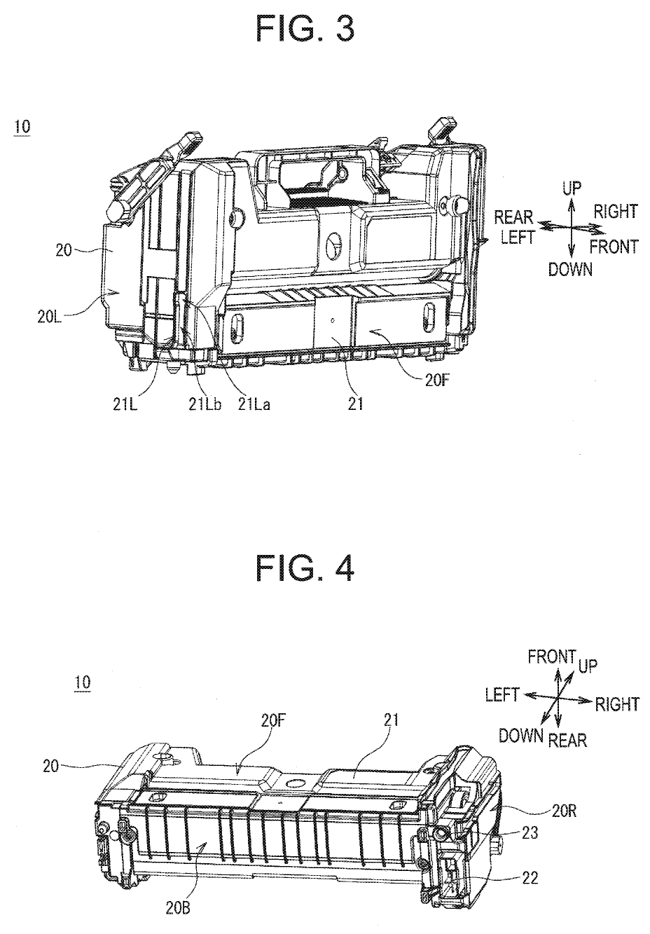

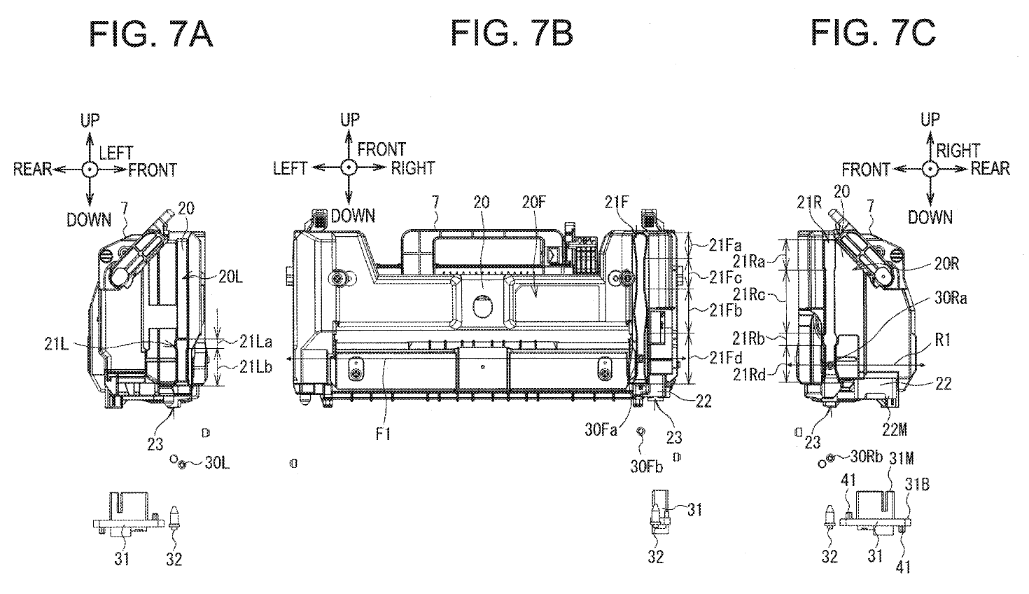

FIG. 2 is an external perspective view showing the fixing device 7 as seen obliquely from the front right. FIG. 3 is an external perspective view showing the fixing device 7 as seen obliquely from the front left. FIG. 4 is an external perspective view showing the fixing device 7 as seen obliquely from rear and below. FIG. 7A is a left-side view showing the left-side face 20L of the cover front 21. FIG. 7B is a front view showing the front face 20F of the cover front 21. FIG. 7C is a right-side view showing the right-side face 20R of the cover front 21. As will be described later, FIGS. 7A to FIG. 10C are transition diagrams showing a flow until the fixing device 7 is attached to the apparatus main body 2. FIGS. 7A to FIG. 10C do not only show the fixing device 7 but also show components provided in the apparatus main body 2.

As shown in FIGS. 2 and 7B, a guide groove 21F is formed in the vicinity of a right end of the front face 20F of the cover front 21. The guide groove 21F extends in a vertical direction from an upper end to a lower end of the front face 20F. An upper end portion and a center portion of the guide groove 21F in the vertical direction are respectively defined as a wider portion 21Fa and a wider portion 21Fb each having a width (length in the left-right direction) wider than the other portions in the guide groove 21F. A portion between the wider portions 21Fa and 21Fb in the guide groove 21F is defined as a narrower portion 21Fc. A portion below the wider portion 21Fb is defined as a narrower portion 21Fd. The reason why the guide groove 21F includes the wider portions 21Fa and 21Fb and the narrower portions 21Fc and 21Fd will be described later.

A lower end side of the guide groove 21F (that is, lower end side of the lower narrower portion 21Fd) is opened, and has a spreading shape such that its width increases downward. Although described later in detail, the reason why the lower end side of the guide groove 21F is opened and has the spread shape is to guide two guide pins 30Fa and 30Fb (see FIG. 7B), which are provided in the apparatus main body 2, into the guide groove 21F through the lower end side of the guide groove 21F when the fixing device 7 is attached to the apparatus main body 2 of the image forming apparatus 1.

In the guide groove 21F, portions of the wider portions 21Fa and 21Fb respectively adjoining the narrower portions 21Fc and 21Fd have tapered shapes such that their widths decrease gradually toward the narrower portions 21Fc and 21Fd. A depth (i.e., length in the front-rear direction) of the guide groove 21F is constant throughout the guide groove 21F.

As shown in FIGS. 2 and 7C, a guide groove 21R is formed in the vicinity of a front end of the right-side face 20R of the cover front 21. The guide groove 21R extends in the vertical direction from an upper end to a lower end of the right-side face 20R. A portion slightly lower than an upper end of the guide groove 21R is defined as a wider portion 21Ra. A portion slightly lower than the center of the guide groove 21R in the vertical direction is defined as a wider portion 21Rb. Each of the wider portions 21Ra and Rb has a width (length in the front-rear direction) wider than other portions in the guide groove 21R. Moreover, a portion between the wider portions 21Ra and 21Rb in the guide groove 21R is defined as a narrower portion 21Rc, and a portion below the wider portion 21Rb in the guide groove 21R is defined as a narrower portion 21Rd. The reason why the guide groove 21R includes the wider portions 21Ra and 21Rb and the narrower portions 21Rc and 21Rd will be described later.

A lower end side of the guide groove 21R (that is, lower end side of the lower narrower portion 21Rd) is opened, and has a spreading shape such that its width increases downward. Although described later in detail, the reason why the lower end side of the guide groove 21R is opened and has the spreading shape is to guide two guide pins 30Ra and 30Rb (see FIG. 7C), which are provided in the apparatus main body 2, into the guide groove 21R through the lower end side of the guide groove 21R when the fixing device 7 is attached to the apparatus main body 2 of the image forming apparatus 1.

In the guide groove 21R, portions of the wider portions 21Ra and 21Rb respectively adjoining the narrower portions 21Rc and 21Rd have tapered shapes such that their widths decrease gradually toward the narrower portions 21Rc and 21Rd. A depth (length in the left-right direction) of the guide groove 21R is constant throughout the guide groove 21R.

Further, as shown in FIGS. 3 and 7A, a guide groove 21L is formed in the vicinity of a front end of the left-side face 20L of the cover front 21. The guide groove 21L extends in the vertical direction from a position slightly lower than the center of the left-side face 20L to the lower end of the left-side face 20L. An upper end portion of the guide groove 21L is defined as a wider portion 21La having a width (length in the front-rear direction) wider than other portions in the groove 21L. In the guide groove 21L, a portion below the wider portion 21La is defined as a narrower portion 21Lb. The reason why the guide groove 21L includes the wider portion 21La and the narrower portion 21Lb will be described later.

A lower end side of the guide groove 21L (that is, lower end side of the narrower portion 21Ld) is opened, and has a spreading shape such that its width increases downward. Although described later in detail, the reason why the lower end side of the guide groove 21L is opened and has the spreading shape is to guide a guide pin 30L (see FIG. 7A), which is provided in the apparatus main body 2, into the guide groove 21L through the lower end side of the guide groove 21L when the fixing device 7 is attached to the apparatus main body 2 of the image forming apparatus 1.

In the guide groove 21L, a portion of the wider portion 21La adjoining the narrower portion 21Lb has a tapered shape such that its width decreases gradually toward the narrower portion 21Lb. A depth (length in the left-right direction) of the guide groove 21L is constant throughout the guide groove 21L.

As shown in FIG. 4, a drawer connector 22 and a positioning hole 23 are provided in the vicinity of a right end of the bottom face 20B of the fixing housing 20. The drawer connector 22 is located at the rear side and the positioning hole 23 is located at the front side. The drawer connector 22 is provided to face downward. Although described later in detail, the drawer connector 22 engages with a drawer connector 31 (see FIG. 7C) provided in the apparatus main body 2 and facing upward when the fixing device 7 is attached to the apparatus main body 2 of the image forming apparatus 1. By bringing the drawer connector 22 into engagement with the drawer connector 31 of the apparatus main body 2, and by moving the fixing device 7 in the attachment direction, the fixing device 7 is electrically connected to the apparatus main body 2. In this embodiment, the expression that the drawer connector 22 and the drawer connector 31 engage with each other means that at least a part of the drawer connector 22 and at least a part of the drawer connector 31 overlap each other in a direction perpendicular to the attaching direction of the fixing device 7.

The positioning hole 23 is a hole extending upward from the bottom face 20B of the fixing housing 20. Although described later in detail, the positioning hole 23 is a hole into which a positioning post 32 (see FIG. 7C) provided in the apparatus main body 2 is inserted when the fixing device 7 is attached to the apparatus main body 2 of the image forming apparatus 1. The positioning post 32 of the apparatus main body 2 is inserted into (i.e., engages with) the positioning hole 23 so that the fixing device 7 is positioned with respect to the apparatus main body 2. In this embodiment, the expression that the positioning hole 23 and the positioning post 32 engage with each other means that at least a part of the positioning hole 23 and at least a part of the positioning post 32 overlap each other in the direction perpendicular to the attachment direction of the fixing device 7.

In this regard, the drawer connector 31 is provided so as to fit into a recess formed in the vicinity of the right end of the bottom face 20B of the fixing housing 20. In the vertical direction of the fixing housing 20, the position of the lower end of the drawer connector 31 and the position of the bottom face 20B of the fixing housing 20 substantially coincide with each other.

Hereinafter, sizes and positions of the guide grooves 21F, 21R, and 21L will be described more detail with reference to FIGS. 7A through 7C.

A length of the guide groove 21F in the vertical direction and a length of the guide groove 21R in the vertical direction are substantially the same. On the other hand, a length of the guide groove 21L in the vertical direction is substantially 1/3 of the length of each of the guide grooves 21F and 21R in the vertical direction.

In the guide groove 21R, a length of the upper wider portion 21Ra in the vertical direction is longer than a length of the lower wider portion 21Rb in the vertical direction.

In the vertical direction of the fixing housing 20, a position of the lower end of the guide groove 21F, a position of the lower end of the guide groove 21R, and a position of the lower end of the guide groove 21L substantially coincide with each other.

In the vertical direction of the fixing housing 20, a position of the upper end of the guide groove 21F and a position of the upper end of the guide groove 21R substantially coincide with each other. In the vertical direction of the fixing housing 20, a position of the wider portion 21Rb of the guide groove 21R and a position of the wider portion 21La of the guide groove 21L substantially coincide with each other.

Further, in the vertical direction of the fixing housing 20, a position of the wider portion 21Fb of the guide groove 21F is located above the position of the wider portion 21Rb of the guide groove 21R and also above the position of the wider portion 21La of the guide groove 21L.

### 1-3. External Configuration of Fixing Device Attachment Portion

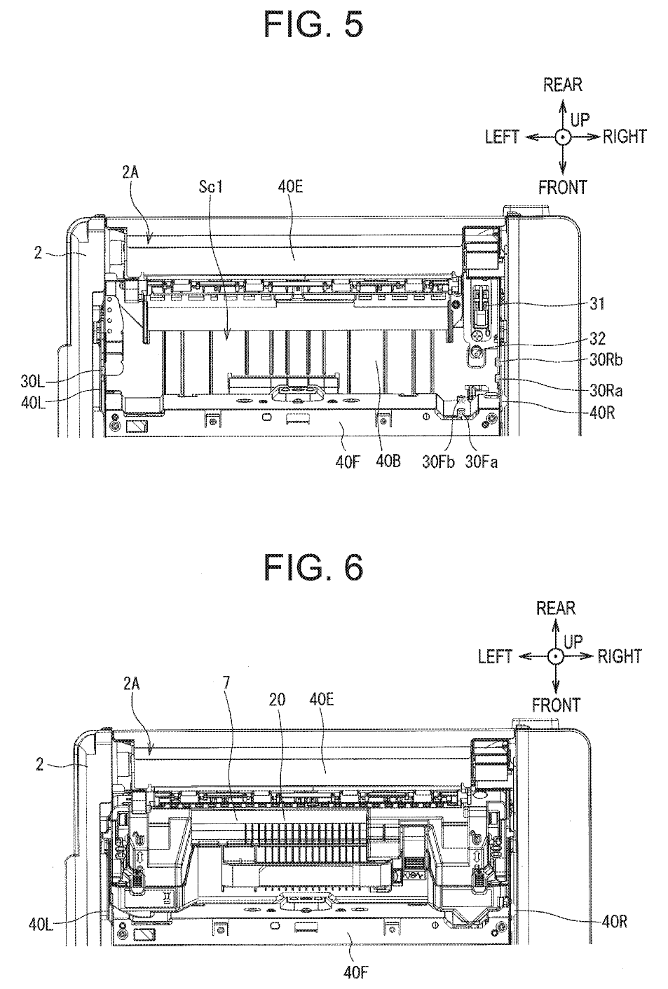

FIGS. 5 and 6 show an external configuration of the fixing device attachment portion 2A to which the fixing device 7 is attached. FIGS. 5 and 6 are top views showing the fixing device attachment portion 2A as seen from above. FIG. 5 shows the fixing device attachment portion 2A in a state where the fixing device 7 is not attached thereto. FIG. 6 shows the fixing device attachment portion 2A in a state where the fixing device 7 is attached thereto.

As shown in FIG. 5, the fixing device attachment portion 2A of the apparatus main body 2 has an accommodation space Sc1 having a substantially box shape with its upper side opened. The accommodation space Sc1 is defined by a front frame 40F facing the front face 20F of the cover front 21 of the fixing device 7, a right-side frame 40R facing the right-side face 20R of the cover front 21, a left-side frame 40L facing the left-side face 20L of the cover front 21, a rear frame 40E facing a rear face of the fixing housing 20, and a bottom frame 40B facing the bottom face 20B of the fixing housing 20. In this regard, each of the frames 40F, 40R, 40L, 40E, and 40B is formed of sheet metal. The frames 40F, 40R, 40L, 40E, and 40B may be integrally formed, or may be separately formed.

The accommodation space Sc1 has a size slightly larger than the fixing housing 20 of the fixing device 7, so that the fixing housing 20 can be accommodated in the accommodation space Sc1. As shown in FIG. 6, the fixing device 7 is attached to the apparatus main body 2 by inserting the fixing device 7 into the accommodation space Sc1 formed in the fixing device attachment portion 2A. In this regard, the accommodation space Sc1 is slightly inclined so that its upper front end is located on the front side with respect to its lower front end. The fixing device 7 is inserted into the accommodation space Sc1 as shown in FIG. 1 in such a manner that the fixing device 7 is slightly inclined so that its upper front end is located on the front side with respect to its lower front end.

As shown in FIG. 5, the front frame 40F is formed of beam sheet metal, for example. The guide pins 30Fa and 30Fb are provided in the vicinity of a right end of the front frame 40F. The guide pin 30Fa is located on the upper side (upstream side in the attachment direction of the fixing device 7), and the guide pin 30Fb is located on the lower side (downstream side in the attachment direction of the fixing device). The guide pins 30Fa and 30Fb project rearward so that an interval is formed between the guide pins 30Fa and 30Fb in the vertical direction. The two guide pin 30Fa and 30Fb have columnar shapes whose diameters are respectively smaller than the widths of the narrower portions 21Fc and 21Fd in the guide groove 21F of the front face 20F of the cover front 21 of the fixing device 7. Moreover, the guide pins 30Fa and 30Fb are located so as to face the guide groove 21F. When the fixing device 7 is attached to the apparatus main body 2 (i.e., when the fixing device 7 is inserted into the accommodation space Sc1), the guide pins 30Fa and 30Fb are inserted into the guide groove 21F. The guide pins 30Fa and 30Fb and the guide groove 21F serve as a guide portion for guiding the fixing device 7 which is being attached.

The guide pins 30Ra and 30Rb are provided in the vicinity of the front end of the right-side frame 40R. The guide pin 30Ra is located on the upper side (upstream side in the attachment direction of the fixing device 7), and the guide pin 30Rb is located on the lower side (downstream side in the attachment direction of the fixing device 7). The guide pins 30Ra and 30Rb project leftward so that an interval is formed between the guide pins 30Ra and 30Rb in the vertical direction. The two guide pins 30Ra and 30Rb have columnar shapes whose diameters are respectively smaller than the widths of the narrower portions 21Rc and 21Rd in the guide groove 21R of the right-side face 20R of the cover front 21 of the fixing device 7. Moreover, the guide pins 30Ra and 30Rb are located so as to face the guide groove 21R. When the fixing device 7 is attached to the apparatus main body 2, the guide pins 30Ra and 30Rb are inserted into the guide groove 21R. The guide pins 30Ra and 30Rb and the guide groove 21R serve as a guide portion for guiding the fixing device 7 which is being attached.

A guide pin 30L is provided in the vicinity of a front end of the left-side frame 40L. The guide pin 30L project rightward. The guide pin 30L has a columnar shape whose diameter is slightly smaller than the width of the narrower portion 21Lb in the guide groove 21L of the left-side face 20L of the cover front 21 of the fixing device 7. Moreover, the guide pin 30L is located so as to face the guide groove 21L. When the fixing device 7 is attached to the apparatus main body 2, the guide pin 30L is inserted into the guide groove 21L. The guide pin 30L and the guide groove 21L serve as a guide portion for guiding the fixing device 7 which is being attached.

The drawer connector 31 facing upward is provided on the front side in the vicinity of a right end of the left-side frame 40B. The positioning post 32 projecting upward is provided on the rear side in the vicinity of the right end of the left-side frame 40B. The drawer connector 31 is located so as to face the downward-facing drawer connector 22 provided on the bottom face 20B of the fixing housing 20 of the fixing device 7. The drawer connector 31 engages with the drawer connector 22 when the fixing device 7 is attached to the apparatus main body 2.

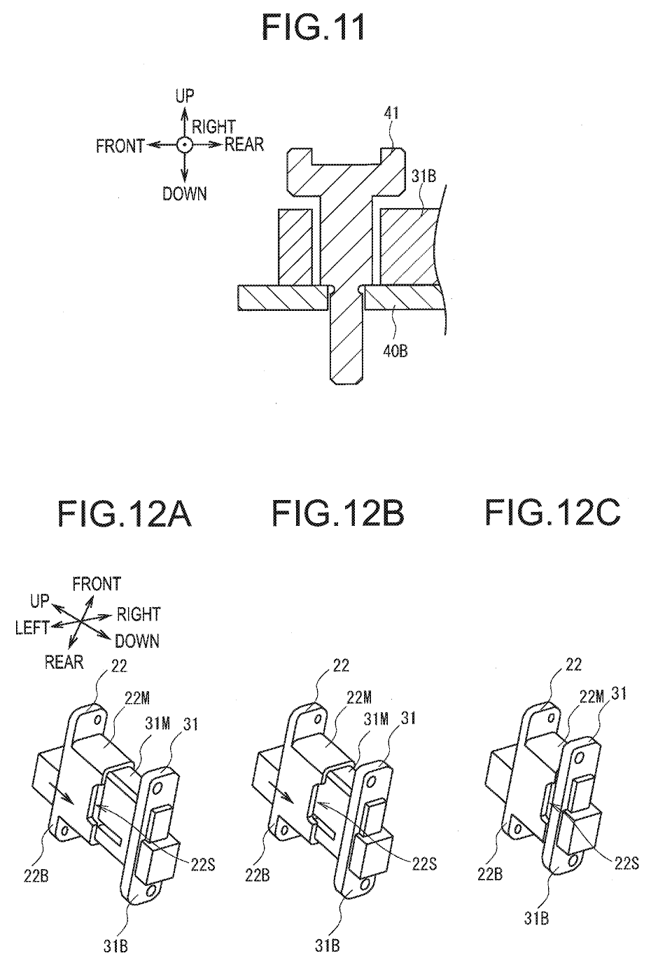

Specifically, as shown in FIG. 7C, the upward-facing drawer connector 31 of the apparatus main body 2 includes a base 31B having a plate-like shape fixed to the bottom frame 40B (not shown in FIG. 7C) with screws 41, and a projecting portion 31M having a substantially rectangular parallelepiped shape and projecting upward from the base 31B. The base 31B of the drawer connector 31 is fixed to the bottom frame 40B with the screws 41 as shown in FIG. 11, which is an enlarged view showing the screw 41 and its surroundings. A gap is provided between the base 31B and the screw 41 so that the base 31B is movable in directions relative to the bottom frame 40B by an amount of the gap between the base 31B and the screw 41 (that is, within a predetermined range). A not-shown terminal is provided at a bottom of a hole provided on an upper face of the projecting portion 31M (FIG. 7C).

As shown in FIG. 7C and FIG. 12A, which is an external perspective view of the drawer connectors 22 and 31, the downward-facing drawer connector 22 of the fixing device 7 includes a base 22B having a plate-like shape fixed to the bottom face 20B (not shown in FIG. 12A), and a projecting portion 22M projecting downward from the base 22B. The projecting portion 22M has a substantially box shape with its lower side opened. The projecting portion 22M has an insertion space 22S therein. The insertion space 22S is slightly larger than the projecting portion 31M of the drawer connector 31 so that the projecting portion 31M can be inserted into the insertion space 22S. A not-shown terminal is provided at a bottom of the insertion space 22S of the drawer connector 22.

As shown in FIGS. 12A through 12C, the drawer connector 31 of the apparatus main body 2 and the drawer connector 22 of the fixing device 7 are configured so that the projecting portion 31M of the drawer connector 31 engages with the insertion space 22 of the drawer connector 22 by inserting the projecting portion 31M of the drawer connector 31 into the insertion space 22S of the drawer connector 22. When the projecting portion 31M of the drawer connector 31 is inserted into the insertion space 22S of the drawer connector 22 to reach the bottom of the insertion space 22S as shown in FIG. 12C, the terminals of the drawer connectors 31 and 22 are brought into contact with and electrically connected to each other.

In this regard, a state where at least a part of the projecting portion 31M of the drawer connector 31 is inserted into the insertion space 22S of the drawer connector 22, and at least a part of the projecting portion 22M of the drawer connector 22 and at least a part of the projecting portion 31M of the drawer connector 31 overlap each other in a direction perpendicular to an inserting direction of the drawer connector 31 (i.e., perpendicular to the attachment direction of the fixing device 7) is referred to as a state where at least a part of the drawer connector 31 engages with at least a part of the drawer connector 22.

As shown in FIG. 7C, the positioning post 32 has a substantially columnar shape with a sharpened tip, and has a diameter slightly smaller than the positioning hole 23 of the fixing housing 20 of the fixing device 7. The positioning post 32 is located so as to face the positioning hole 23. The positioning post 32 is inserted into the positioning hole 23 when the fixing device 7 is attached to the apparatus main body 2. In this regard, an upper end of the positioning post 32 is located at a position slightly lower than an upper end of the projecting portion 31M of the drawer connector 31. Thus, when the fixing device 7 is attached to the apparatus main body 2, the positioning post 32 is inserted into the positioning hole 23 after the drawer connector 22 and the drawer connector 31 start to engage with each other.

Hereinafter, positions of the guide pins 30Fa, 30Fb, 30Ra, 30Rb, and 30L will be described more detail with reference to FIGS. 7A through 7C. In this regard, the fixing device 7 is attached to the apparatus main body 2 in a state where the fixing device 7 is inclined as described above. However, for ease of explanation, inclination of the fixing device 7 is omitted in FIGS. 7A through 10C.

In the vertical direction of the apparatus main body 2, the position of the guide pin 30Fa provided on the front frame 40F and the position of the guide pin 30Ra provided on the right-side frame 40R substantially coincide with each other.

Further, in the vertical direction of the apparatus main body 2, the position of the guide pin 30Rb provided on the right-side frame 40R and the position of the guide pin 30L provided on the left-side frame 40L substantially coincide with each other.

Further, in the vertical direction of the apparatus main body 2, a position of the guide pin 30Fb provided on the front frame 40F is located above the position of the guide pin 30Rb of the right-side frame 40R and the position of the guide pin 30L of the left-side frame 40L.

### 1-4. Attachment of Fixing Device

Next, the attachment of the fixing device 7 will be described with reference to FIGS. 7A through FIG. 10C. In this regard, the fixing device 7 is attached to the apparatus main body 2 in a state where the fixing device 7 is slightly inclined as described above. However, for ease of explanation, the inclination of the fixing device 7 is omitted in FIGS. 7A through 10C. Thus, although the attachment direction of the fixing device 7 is illustrated as being downward in FIGS. 7A through 10C, the actual attachment direction of the fixing device 7 is obliquely rearward and downward.

When the fixing device 7 is attached to the apparatus main body 2, first, the position of the fixing device 7 is adjusted above the accommodation space Sc1 (FIG. 5) so that the lower end of the guide groove 21F of the front face 20F (FIG. 2) of the fixing device 7 is located above the upper guide pin 30Fa of the front frame 40F (FIG. 5) of the apparatus main body 2, and the lower end of the guide groove 21R of the right-side face 20R (FIG. 2) of the fixing device 7 is located above the upper guide pin 30Ra of the right-side frame 40R of the apparatus main body 2. Then, the fixing device 7 is inserted into the accommodation space Sc1.

As the fixing device 7 is inserted into the accommodation space Sc1, the upper guide pin 30Fa is inserted into the guide groove 21F through the lower end side of the guide groove 21F as shown in FIG. 7B, and the upper guide pin 30Ra is inserted into the guide groove 21R through the lower end side of the guide groove 21R as shown in FIG. 7C.

In this regard, FIGS. 7A through 7C show a state where the upper guide pin 30Fa is passing through the inside of the lower narrower portion 21Fd in the guide groove 21F, and the upper guide pin 30Ra is passing through the inside of the lower narrower portion 21Rd in the guide groove 21R.

As shown in FIG. 7B, movement of the upper guide pin 30Fa in a width direction of the guide groove 21F (left-right direction) is restricted. In other words, the movement of the guide pin 30Fa in the width direction of the guide groove 21F (left-right direction) is limited within the width of the narrower portion 21Rd. Thus, movement of the fixing device 7 in the left-right direction as shown by an arrow F1 is restricted. Moreover, as shown in FIG. 7C, the movement of the upper guide pin 30Ra in a width direction of the guide groove 21R (front-rear direction) is restricted. Thus, the movement of the fixing device 7 in the front-rear direction as shown by an arrow R1 is restricted. At this stage, the drawer connector 22 of the fixing device 7 is apart from the drawer connector 31 of the apparatus main body 2. In other words, the drawer connector 31 of the apparatus main body 2 is located at a position apart from the drawer connector 22 of the fixing device 7 in the attachment direction of the fixing device 7.

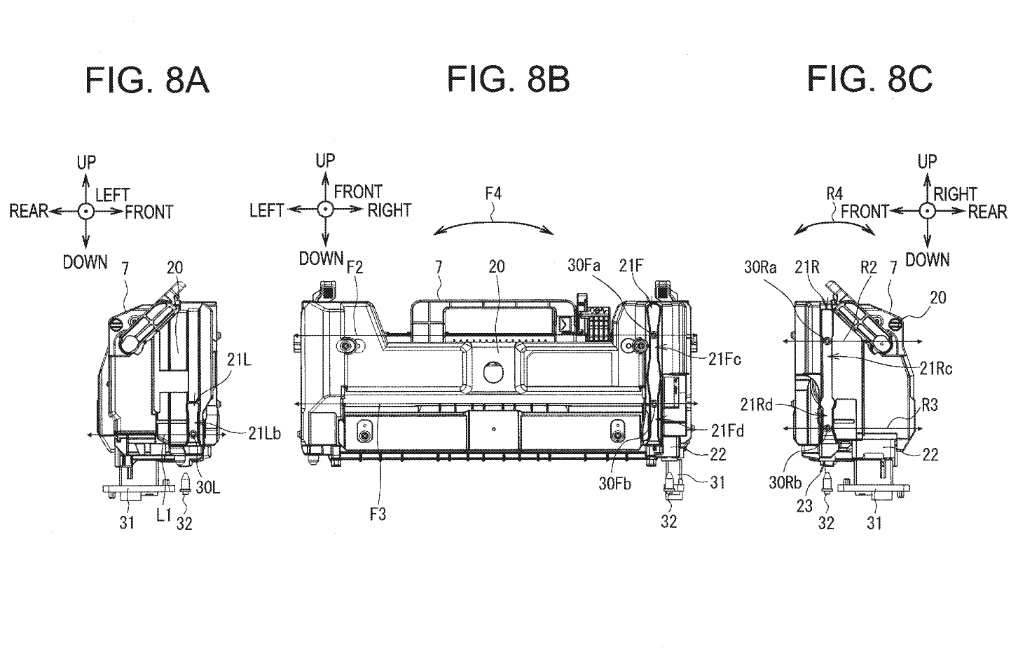

Thereafter, when the fixing device 7 is inserted to a position just before the drawer connector 22 and the drawer connector 31 start to engage with each other as shown in FIG. 8B, the upper guide pin 30Fa reaches the upper narrower portion 21Fc in the guide groove 21F, and the lower guide pin 30Fb is inserted into the guide groove 21F to reach the lower narrower portion 21Fd.

Thus, movement of the guide pins 30Fa and 30Fb in the width direction of the guide groove 21F (left-right direction) is restricted. Therefore, the movement of the fixing device 7 in the left-right direction as shown by arrows F2 and F3 is restricted, and inclination of the fixing device 7 in the left-right direction as shown by an arrow F4 is restricted.

Moreover, as shown in FIG. 8C, the upper guide pin 30Ra reaches the upper narrower portion 21Rc in the guide groove 21R at this stage, and the lower guide pin 30Rb is inserted into the guide groove 21R to reach the lower narrower portion 21Rd.

Thus, movement of the guide pins 30Ra and 30Rb in the width direction of the guide groove 21R (front-rear direction) is restricted. Therefore, the movement of the fixing device 7 in the front-rear direction as shown by arrows R2 and R3 is restricted, and the inclination of the fixing device 7 in the front-rear direction as shown by an arrow R4 is restricted.

Further, as shown in FIG. 8A, the guide pin 30L of the apparatus main body 2 is inserted into the guide groove 21L of the fixing device 7, and reaches the narrower portion 21Lb of the guide groove 21L. Thus, movement of the guide pin 30L in the width direction of the guide groove 21L (front-rear direction) is restricted. Thus, the movement of the fixing device 7 in the front-rear direction as shown by an arrow L1 is restricted.

Consequently, in the image forming apparatus 1, when the fixing device 7 is attached to the apparatus main body 2, the drawer connector 22 of the fixing device 7 is guided to the drawer connector 31 of the apparatus main body 2 while restricting the movement of the fixing device 7 in the front-rear direction and in the left-right direction and the inclination of the fixing device 7 in the left-right direction. Accordingly, in the image forming apparatus 1, the drawer connector 22 of the fixing device 7 can be accurately guided to the drawer connector 31 of the apparatus main body 2 while restricting the displacement and inclination of the fixing device 7.

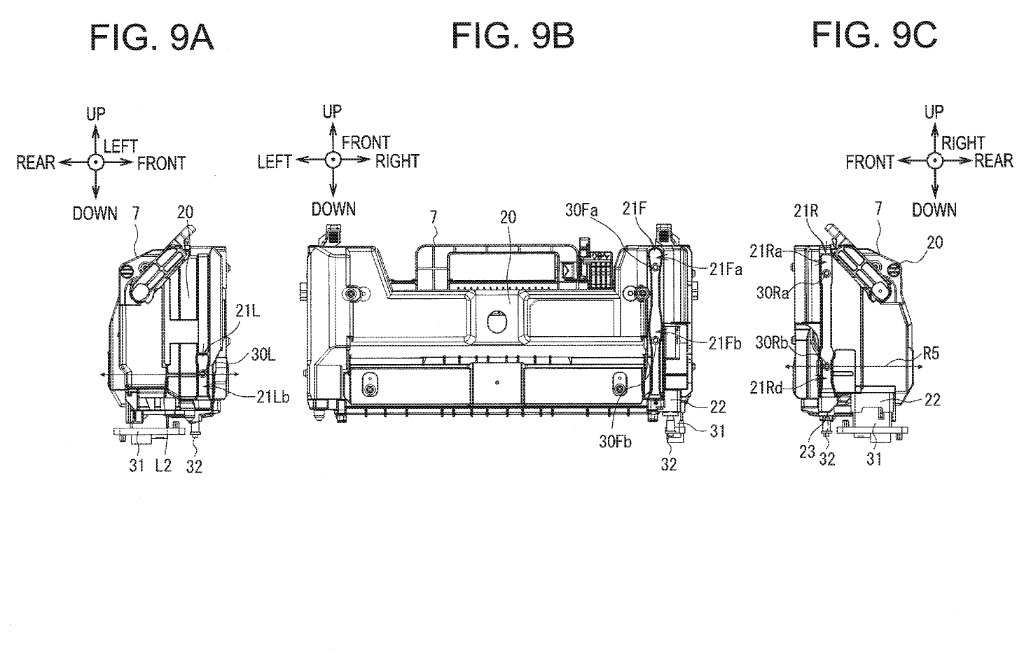

Thereafter, as shown in FIGS. 9A through 9C, the fixing device 7 is inserted until the lower end of the drawer connector 22 and the upper end of the drawer connector 31 start to engage with each other (see FIG. 12B) and the upper end of the positioning post 32 starts to be inserted into the positioning hole 23. In this regard, the drawer connector 31 starts to engage with the drawer connector 22, while moving in accordance with the position of the drawer connector 22.

As shown in FIG. 9A, the guide pin 30L is passing through the narrower portion 21Lb in the guide groove 21L at this stage. Thus, movement of the guide pin 30L in the width direction of the guide groove 21L (front-rear direction) is restricted. Therefore, the movement of the fixing device 7 in the front-rear direction as shown by an arrow L2 is restricted.

At this stage, as shown in FIG. 9B, the upper guide pin 30Fa reaches the upper wider portion 21Fa in the guide groove 21F, and the lower guide pin 30Fb reaches the lower wider portion 21Fb. Thus, restriction of the movement of the guide pins 30Fa and 30Fb in the width direction of the guide groove 21F (left-right direction) is loosened. In other words, the movement of the guide pins 30Fa and 30Fb in the width direction of the guide groove 21F (left-right direction) is limited within the widths of the wider portions 21Fa and 21Fb which are wider than the narrower portion 21Fc and 21Fd. Therefore, the restriction of the movement of the fixing device 7 in the left-right direction is loosened, and the restriction of the inclination of the fixing device 7 in the left-right direction is loosened.

Further, at this stage, as shown in FIG. 9C, the upper guide pin 30Ra reaches the upper wider portion 21Ra in the guide groove 21R, and the lower guide pin 30Rb is passing through the lower narrower portion 21Rd. Thus, while the restriction of the movement of the guide pin 30Ra in the width direction of the guide groove 21R (front-rear direction) is loosened, the movement of the guide pin 30Rb in the width direction of the guide groove 21R (front-rear direction) is restricted. Therefore, while the movement of the fixing device 7 in the front-rear direction as shown by an arrow R5 is restricted, the restriction of the inclination of the fixing device 7 in the front-rear direction is loosened.

Consequently, during the attachment of the fixing device 7 to the apparatus main body 2 of the image forming apparatus 1, while the movement of the fixing device 7 in the front-rear direction is restricted, the restriction of the inclination of the fixing device 7 in the front-rear direction and the movement and inclination of the fixing device 7 in the left-right direction is loosened, when the drawer connector 22 of the fixing device 7 and the drawer connector 31 of the apparatus main body 2 start to engage with each other and the positioning post 32 starts to be inserted into the positioning hole 23, i.e., when at least a part of the positioning hole 23 and at least a part of the positioning post 32 start to overlap each other in the direction perpendicular to the inserting direction of the positioning post 32 (i.e., attachment direction of the fixing device 7).

In this regard, more specifically, in the image forming apparatus 1, the positioning post 32 starts to be inserted into the positioning hole 23 after the drawer connector 22 and the drawer connector 31 start to engage with each other. The guide pins 30Fa and 30Ra respectively reach the wider portions 21Fa and 21Ra when the drawer connector 22 and the drawer connector 31 start to engage with each other (that is, before the positioning post 32 starts to be inserted into the positioning hole 23).

Accordingly, when the drawer connector 22 of the fixing device 7 and the drawer connector 31 of the apparatus main body 2 start to engage with each other and the positioning post 32 starts to be inserted into the positioning hole 23, the fixing device 7 is allowed to be inclined in the front-rear direction and left-right direction and to move in the left-right direction. Thus, misalignment of the drawer connector 22 and the drawer connector 31 due to the manufacturing error can be absorbed, so that the drawer connector 22 and the drawer connector 31 can appropriately engage with each other without being interrupted. Further, misalignment of the positioning hole 32 and the positioning post 23 due to the manufacturing error can be absorbed, so that the positioning post 23 can be appropriately inserted into the positioning hole 32 without being interrupted.

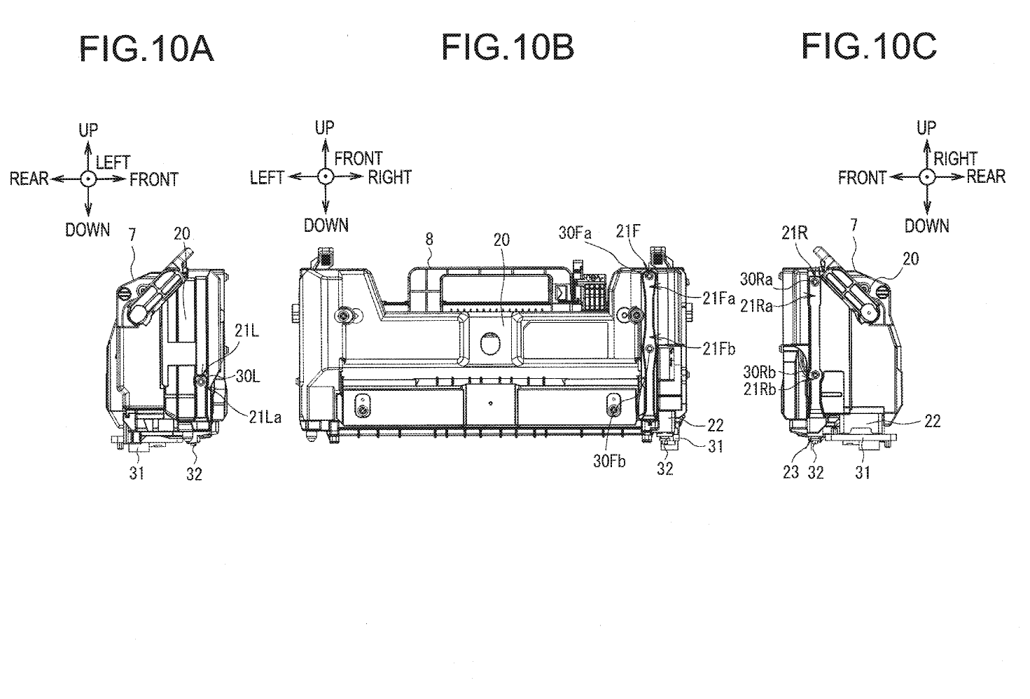

Thereafter, when the fixing device 7 is further inserted into the accommodation space Sc1, the fixing device 7 is accommodated in the accommodation space Sc1 as shown in FIG. 6, and the drawer connectors 22 and 31 engage with each other so that the terminals thereof are brought into contact with and electrically connected to each other (FIG. 12C) and the positioning post 32 is entirely inserted into the positioning hole 23 as shown in FIGS. 10A through 10C. Consequently, the attachment of the fixing device 7 to the apparatus main body 2 is completed.

At this stage, as shown in FIG. 10A, the guide pin 30L reaches the wider portion 21La in the guide groove 21L. Thus, the restriction of the movement of the guide pin 30L in the width direction of the guide groove 21L (front-rear direction) is loosened.

At this stage, moreover, as shown in FIG. 10B, the upper guide pin 30Fa is still located in the upper wider portion 21Fa in the guide groove 21F, and the lower guide pin 30Fb is still located in the lower wider portion 21Fb. Thus, the restriction of the movement of the guide pins 30Fa and 30Fb in the width direction of the guide groove 21F (left-right direction) is kept being loosened.

At this stage, further, as shown in FIG. 10C, the upper guide pin 30Ra is still located in the upper wider portion 21Ra in the guide groove 21R, and the lower guide pin 30Rb reaches the lower wider portion 21Rb. Thus, the restriction of the movement of the guide pin 30Ra in the width direction of the guide groove 21R (front-rear direction) is kept being loosened, and the restriction of the movement of the guide pin 30Rb in the width direction of the guide groove 21R (front-rear direction) is loosened.

Consequently, in the image forming apparatus 1, when the attachment of the fixing device 7 to the apparatus main body 2 is completed, the engagement between the drawer connector 31 and the drawer connector 22 is completed and the insertion of the positioning post 32 into the positioning hole 23 is completed, the restriction of the movement and inclination of the fixing device 7 is all loosened since the positioning of the fixing device 7 with respect to the apparatus main body 2 is performed by the positioning post 32.

### 1-5. Conclusion and Effects

As described above, according to the first embodiment, the image forming apparatus 1 serving as an electronic apparatus includes the apparatus main body 2, and the fixing device 7 serving as an attachment-detachment device and being attachable to and detachable from the apparatus main body 2. The apparatus main body 2 has the guide pin 30Ra serving as a first engagement portion or a first projecting portion. The guide pin 30Ra is provided on an end side of the apparatus main body 2 in a crossing direction (left-right direction) crossing the attachment direction of the fixing device 7 (i.e., provided on the right-side frame 40R). The fixing device 7 has the guide groove 21R serving as a first to-be-engaged portion or a first groove portion. The guide groove 21R is engageable with the guide pin 30Ra and extends in the attachment direction of the fixing device 7.

Further, the fixing device 7 includes the drawer connector 22 serving as a second connector. When the fixing device 7 is attached to the apparatus main body 2, the drawer connector 22 approaches the drawer connector 31 serving as a first connector and engages with the drawer connector 31 to be connected to the drawer connector 31.

Further, the guide groove 21R includes the narrower portion 21Rc serving as a first region and the wider portion 21Ra serving as a second region. During the attachment of the fixing device 7 to the apparatus main body 2, the guide pin 30Ra passes through the narrower portion 21Rc in a state where the drawer connector 31 and the drawer connector 22 do not engage each other and are apart from each other (see FIGS. 8A through 8C), and the guide pin 30Ra passes through the wider portion 21Ra after at least a part of the drawer connector 31 and at least a part of the drawer connector 22 engage with each other (see FIGS. 9A through 10C).

The movable range of the guide pin 30Ra with respect to the guide groove 21R in the direction (i.e., width direction of the guide groove 21R or front-rear direction) perpendicular to the attachment direction of the fixing device 7 is wider when the guide pin 30Ra passes through the wider portion 21Ra than when the guide pin 30Ra passes through the narrower portion 21Rc in the guide groove 21R. To be more specific, the movable range of the guide pin 30Ra with respect to the guide groove 21R in the direction perpendicular to both of the attachment direction of the fixing device 7 (i.e., downward) and the direction from one end side to the other end side of the fixing device 7 (i.e., longitudinal direction or left-right direction) is wider when the guide pin 30Ra passes through the wider portion 21Ra than when the guide pin 30Ra passes through the narrower portion 21Rc in the guide groove 21R.

Accordingly, in the image forming apparatus 1, during the attachment of the fixing device 7 to the apparatus main body 2, in a state where the drawer connector 22 and the drawer connector 31 are apart from each other, the guide pin 30Ra passes through the narrower portion 21Rc in the guide groove 21R, and thus displacement, inclination and the like of the fixing device 7 can be restricted. Therefore, the drawer connector 22 is accurately guided to the drawer connector 31.

Further, in the image forming apparatus 1, after at least a part of the drawer connector 22 engages with at least a part of the drawer connector 31 (that is, from when the drawer connector 22 and the drawer connector 31 start to engage with each other), the guide pin 30Ra passes through the wider portion 21Ra of the guide groove 21R. Thus, restriction of the displacement, inclination and the like of the fixing device 7 is loosened, so that the misalignment of the drawer connectors 22 and 31 due to the manufacturing error is absorbed. Thus, the drawer connectors 22 and 31 can appropriately engage with each other without being interrupted. Therefore, according to the image forming apparatus 1 of this embodiment, the drawer connectors 22 and 31 can be appropriately connected to each other with ease.

Further, in the image forming apparatus 1 of this embodiment, the apparatus main body 2 includes the guide pin 30Rb serving as a second engagement portion located at a downstream side of the guide pin 30Ra of the apparatus main body 2 in the attachment direction of the fixing device 7. Further, the guide groove 21R serving as a first to-be-engaged portion has the narrower portion 21Rd serving as a third region through which the guide pin 30Rb passes when the guide pin 30Ra passes through the wider portion 21Ra.

Furthermore, in the width direction of the guide groove 21R (front-rear direction), the movable range of the guide pin 30Rb passing through the narrower portion 21Rd serving as the third region is narrower than the movable range of the guide pin 30Ra passing through the narrower portion 21Ra serving as the second region.

That is, in the image forming apparatus 1, after at least a part of the drawer connector 22 engages with at least a part of the drawer connector 31, the movement of the fixing device 7 in the width direction of the guide groove 21R is restricted at a side closer to the drawer connector 22, and the restriction of the movement of the fixing device 7 in the width direction of the guide groove 21R is loosened at a side farther from the drawer connector 22 (i.e., at a side closer to the wider portion 21Ra).

Accordingly, in the image forming apparatus 1, the fixing device 7 can be inclined by moving the side of the fixing device 7 farther from the drawer connector 22 in the width direction of the guide groove 21R without moving the side of the fixing device 7 closer to the drawer connector 22. Thus, the drawer connector 22 and the drawer connector 31 can appropriately engage with each other while absorbing the misalignment of the drawer connectors 22 and 31 due to the manufacturing error without causing damage to the drawer connectors 22 and 31.

Further, in the image forming apparatus 1 of this embodiment, the fixing device 7 includes the positioning hole 23 serving as a positioning to-be-engaged portion. The positioning hole 23 approaches the positioning post 32 serving as a positioning engagement portion of the apparatus main body 2 when the fixing device 7 is attached to the apparatus main body 2, and engages with the positioning post 32 after the drawer connector 31 starts engaging with the drawer connector 22.

Further, the guide pin 30Rb passes through the narrower portion 21Rd until the positioning post 32 is inserted into the positioning hole 23 (i.e., until the positioning post 32 engages with the positioning hole 23). Accordingly, the displacement of the positioning post 32 at a portion closer to the positioning hole 23 is restricted, so that the positioning post 32 can be accurately inserted into the positioning hole 23. Thus, the positioning of the fixing device 7 can be appropriately performed.

Further, in the image forming apparatus 1 of this embodiment, the wider portion 21Rb serving as a fourth region is provided on a downstream side of the narrower portion 21Rc in the guide groove 21R in the inserting direction. The guide pins 30Ra and 30Rb and the guide groove 21R serve as a guide portion. When the attachment of the fixing device 7 is completed, the guide pin 30Ra is located in the wider portion 21Ra and the guide pin 30Rb is located in the narrower portion 21Rb. In other words, the guide groove 21R includes the wider portion 21Ra serving as a first area, the narrower portion 21Rc serving as a second area, the wider portion 21Rb serving as a third area, and the narrower portion 21Rd serving as a fourth area which are arranged in this order from upstream side in the attachment direction. When the attachment of the fixing device 7 is completed, the guide pins 30Ra and 30Rb are respectively located in the wider portions 21Ra and 21Rb.

Accordingly, in the image forming apparatus 1, when the attachment of the fixing device 7 is completed, the restriction by the guide pins 30Ra and 30Rb and the guide groove 21R is all loosened.

Further, the apparatus main body 2 includes the guide pin 30L serving as an engagement portion or a projecting portion provided on the other end side in the direction crossing the attachment direction of the fixing device 7 (that is, provided on the left-side frame 40L). The fixing device 7 includes the guide groove 21L serving as a to-be-engaged portion or a guiding portion which is engageable with the guide pin 30L.

Further, the guide groove 21L includes the narrower portion 21Lb serving as a region through which the guide pin 30L passes in a state where the drawer connector 31 and the drawer connector 22 do not engage with each other and are apart from each other (see FIG. 8A through 8C) during the attachment of the fixing device 7 to the apparatus main body 2, and the wider portion 21La serving as a region through which the guide pin 30L passes after at least a part of the drawer connector 31 and at least a part of the drawer connector 22 engage with each other (see FIGS. 9A through 10C).

The movable range of the guide pin 30L with respect to the guide groove 21L in the direction (i.e., width direction of the guide groove 21L or front-rear direction) perpendicular to both of the attachment direction of the fixing device 7 and the direction from one side to the other side of the fixing device 7 (left-right direction) is wider when the guide pin 30L passes through the wider portion 21La than when the guide pin 30L passes through the narrower portion 21Lb of the guide groove 21L.

Consequently, the image forming apparatus 1 includes the guide pins 30L and 30Ra and the guide grooves 21L and 21R provided on both sides of the fixing device 7, and therefore the fixing device 7 can be attached to the apparatus main body 2 more smoothly.

### 2. SECOND EMBODIMENT

Next, a second embodiment will be described. The second embodiment is different from the first embodiment in a mechanism in which the fixing device 7 is attached to the apparatus main body 2. Hereinafter, description will be focused on differences from the first embodiment. An image forming apparatus, an apparatus main body and a fixing device of the second embodiment will be respectively referred to as an image forming apparatus 100, an apparatus main body 110 and a fixing device 120 in order to distinguish them from their correspondences in the first embodiment.

### 2-1. External Configuration of Fixing Device

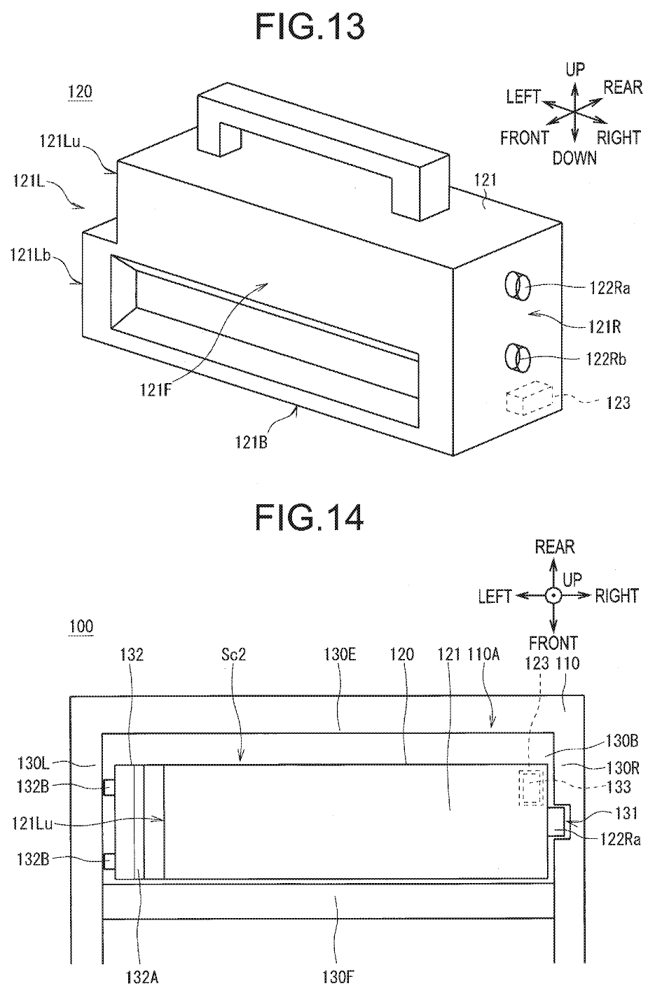

FIG. 13 shows an external configuration of the fixing device 120 in the second embodiment. In this regard, FIG. 13 is an external perspective view showing the fixing device 120 in a simplified manner as seen obliquely from the front right. The fixing device 120 includes a fixing housing 121 as an enclosure. The fixing housing 121 has a substantially rectangular parallelepiped shape elongated in the left-right direction.

As shown in FIG. 13, an upper guide pin 122Ra and a lower guide pin 122Rb are provided on a right-side face 121R of the fixing housing 121. The guide pins 122Ra and 122Rb protrude rightward so that an interval is formed between the guide pins 122Ra and 122Rb in the vertical direction. The guide pins 122Ra and 122Rb are guide pins which are similar to the guide pins 22Ra and 22Rb in the first embodiment, and are inserted into a guide groove 131 of the apparatus main body 110 when the fixing device 120 is attached to the apparatus main body 110.

Moreover, a left-side face 121L of the fixing housing 121 has a stepped shape and includes an upper portion 121Lu and a lower portion 121Lb. The upper portion 121Lu is recessed rightward with respect to the lower portion 121Lb. A drawer connector 123 facing downward is provided in the vicinity of a right end of a bottom face 121B of the fixing device 121. The drawer connector 123 is a drawer connector similar to the drawer connector 22 in the first embodiment, and engages with a drawer connector 133 of the apparatus main body 110 when the fixing device 120 is attached to the apparatus main body 110.

### 2-2. External Configuration of Fixing Device Attachment Portion

FIG. 14 shows an external configuration of a fixing device attachment portion 110A provided in the apparatus main body 110 of the image forming apparatus 100. FIG. 14 is a plan view showing the fixing device attachment portion 110A as seen from above in a state where the fixing device 120 is attached to the fixing device attachment portion 110A.

As shown in FIG. 14, the fixing device attachment portion 110A has an accommodation space Sc2 having a substantially box shape with its upper side opened. The accommodation space Sc2 is defined by a front frame 130F facing a front face 121F of the fixing housing 121 of the fixing device 120, a right-side frame 130R facing a right-side face 121R of the fixing housing 121, a left-side frame 130L facing a left-side face 121L of the fixing housing 121, a rear frame 130E facing a rear face of the fixing housing 121, and a bottom frame 130B facing a bottom face 121B of the fixing housing 121. The frames 130F, 130R, 130L, 130E, and 130B may be integrally formed, or may be separately formed.

The fixing device 120 is attached to the apparatus main body 110 by inserting the fixing device 120 into the accommodation space Sc2 formed in the fixing device attachment portion 110A. The accommodation space Sc2 has a length in the left-right direction longer than a length of the fixing device 120 in the left-right direction. Thus, the fixing device 120 is inserted into the accommodation space Sc2 while being moved toward the right-side frame 130R.

A guide groove 131 is provided on the right-side frame 130R forming the accommodation space Sc2. The guide groove 131 extends in the vertical direction from the upper end to the vicinity of the lower end of the right-side frame 130R. The guide groove 131 is a guide groove similar to the guide groove 21R in the first embodiment. The guide groove 131 has a wider portion and a narrower portion which are not shown. When the fixing device 120 is attached to the apparatus main body 110, guide pins 122Ra and 122Rb provided in the fixing device 120 are inserted into the guide groove 131 having the wider portion and the narrower portion.

A pressing portion 132 is provided on an upper part of the left-side frame 130L. The pressing portion 132 includes a contact portion 132A that is temporarily in contact with a lower portion 121Lb of the left-side face 121L of the fixing housing 121 (but is not in contact with the upper portion 121Lu) when the fixing device 120 is attached to the apparatus main body 110, and a biasing member 132A such as a spring that biases the contact portion 132A in a direction away from the left-side frame 130L.

When the fixing device 120 is attached to the apparatus main body 110, the pressing portion 132 presses the fixing housing 121 toward the right-side frame 130R of the apparatus main body 110 by a biasing force of the biasing member 132B, while the contact portion 132A is in contact with the lower portion 121Lb of the left-side face 121L of the fixing housing 121.

Further, a drawer connector 133 facing upward is provided in the vicinity of the right end of the bottom frame 130B. The drawer connector 133 is a drawer connector similar to the drawer connector 31 in the first embodiment. When the fixing device 120 is attached to the apparatus main body 110, the drawer connector 133 engages with the drawer connector 123 provided in the apparatus main body 110.

### 2-3. Attachment of Fixing Device

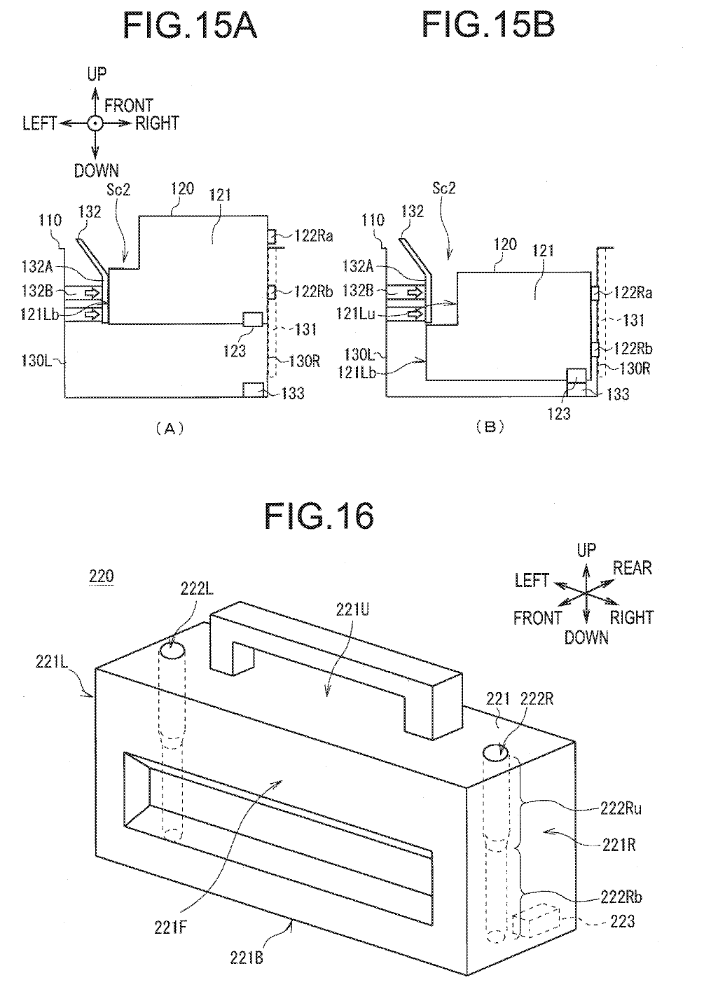

Next, the attachment of the fixing device 120 will be described with reference to FIGS. 15A and 15B. FIGS. 15A and 15B are front views showing the fixing device attachment portion 110A as seen from front. In FIGS. 15A and 15B, the front frame 130F is omitted. The fixing device 120 is attached to the apparatus main body 110 in a state where the fixing device 120 is slightly inclined as in the first embodiment. However, for ease of explanation, the inclination of the fixing device 120 is omitted in FIGS. 15A and 15B.

The positional relationship between the guide groove 131 and the guide pins 122Ra and 122Rb during the attachment of the fixing device 120 is similar to that in the first embodiment, and therefore description thereof is omitted.

FIG. 15A shows a state where the fixing device 120 starts to be inserted into the accommodation space Sc2, the lower guide pin 122Rb of the fixing device 120 is inserted into the guide groove 131 of the apparatus main body 110, and the contact portion 132A of the pressing portion 132 provided in the apparatus main body 110 is in contact with the lower portion 121Lb of the left-side face 121L of the fixing device 120.

In this regard, a lower portion of the contact portion 132A of the pressing portion 132 is substantially parallel to the lower portion 121Lb of the left-side face 121L of the fixing device 120, and an upper portion of the contact portion 132A is inclined obliquely leftward and upward. Thus, the fixing device 120 can be smoothly accommodated in the accommodation space Sc2 while being moved toward the right side in the accommodation space Sc2.

As shown in FIG. 15A, the fixing device 120 is pressed by the pressing portion 132 toward the right-side frame 130R, and it is ensured that the guide pin 122Rb of the fixing device 120 is inserted into the guide groove 31 of the apparatus main body 110. Thus, movement of the fixing device 120 in the front-rear direction and in the left-right direction and the inclination of the fixing device 120 in the left-right direction are restricted.

Then, when the fixing device 120 is further inserted, the lower guide pin 122Rb and the upper guide pin 122Ra of the fixing device 120 are both inserted into the guide groove 131. Thus, the movement of the fixing device 120 in the front-rear direction and in the left-right direction and the inclination of the fixing device 120 in the front-rear direction and in the left-right direction are restricted.

Then, as shown in FIG. 15B, the fixing device 120 is inserted until the lower end of the drawer connector 123 and the upper end of the drawer connector 133 start to engage with each other.

At this stage, the lower portion 121Lb of the left-side face 121L has already passed through the pressing portion 132, and the pressing portion 132 is apart from both of the upper portion 121Lu and the lower portion 121Lb of the left-side face 121L of the fixing device 120, by which the pressing by the pressing member 132 is released. Thus, the restriction of the movement and inclination of the fixing device 120 in the left-right direction by the pressing portion 132 is loosened.

Consequently, in the image forming apparatus 100, until the drawer connector 123 and the drawer connector 133 start to engage with each other, the drawer connector 123 can be accurately guided to the drawer connector 133 while restricting the displacement, inclination and the like of the fixing device 120. After the drawer connector 123 and the drawer connector 133 start to engage with each other, the restriction of the displacement, inclination and the like of the fixing device 120 is loosened, so that misalignment of the drawer connectors 123 and 133 due to the manufacturing error is absorbed. Thus, the drawer connector 123 and the drawer connector 133 can appropriately engage with each other without being interrupted.

Thereafter, as the fixing device 120 is further inserted into the accommodation space Sc2, the fixing device 120 is accommodated in the accommodation space Sc2, and the drawer connector 123 and the drawer connector 133 engage with each other so that the terminals thereof are electrically connected to each other. In this way, the attachment of the fixing device 120 to the apparatus main body 110 is completed. The guide pins 122Ra and 122Rb reach the wider portions (not shown) in the guide groove 131, and the restriction of the movement and inclination of the fixing device 120 is all loosened.

In this regard, although a positioning hole and a positioning post are omitted in the second embodiment, the positioning hole and the positioning post may be provided as in the first embodiment to determine the position of the fixing device 120. Moreover, in the above-described first embodiment, the positioning hole and the positioning post may be omitted as in the second embodiment.

### 2-4. Conclusion and Effects

As described above, in the second embodiment, the image forming apparatus 100 serving as an electronic apparatus includes the apparatus main body 110 and the fixing device 120 serving as an attachment-detachment device and being attachable to and detachable from the apparatus main body 110.

The fixing device 120 include the drawer connector 123 serving as a second connector. When the fixing device 120 is attached to the apparatus main body 110, the drawer connector 123 approaches and engages with the drawer connector 133 serving as a first connector provided in the apparatus main body 110 so that the drawer connector 123 is connected to the drawer connector 133.

In the fixing device 120, the upper portion 121Lu of the left-side face 121L is recessed rightward with respect to the lower portion 121Lb. Further, in the apparatus main body 110, the pressing portion 132 is provided on the left-side face 121L. The pressing portion 132 is capable of being in contact with the lower portion 121Lb of the left-side face 121L of the fixing device 120 to press the fixing device 120 toward the right-side frame 130R.

During the attachment of the fixing device 120 to the apparatus main body 110, when the drawer connector 133 and the drawer connector 123 do not engage with each other and are apart from each other (see FIG. 15A), the pressing portion 132 is in contact with the lower portion 121Lb of the left-side face 121L of the fixing device 120 to press the fixing device 120 toward the right-side frame 130R. After at least a part of the drawer connector 133 engages with at least a part of the drawer connector 123 (see FIG. 15B), the pressing portion 132 is apart from the lower portion 121Lb of the left-side face 121L of the fixing device 120.

Consequently, in the image forming apparatus 100, during the attachment of the fixing device 120 to the apparatus main body 110, in a state where the drawer connector 123 and the drawer connector 133 are apart from each other, the pressing portion 132 presses the fixing device 120 toward the right-side frame 130R. Thus, the displacement, inclination and the like of the fixing device 120 are restricted, so that the drawer connector 123 can be accurately guided to the drawer connector 133.

Further, in the image forming apparatus 100, after at least a part of the drawer connector 123 engages with at least a part of the drawer connector 133 (that is, after the drawer connector 123 and the drawer connector 133 start to engage with each other), the pressing portion 132 is apart from the lower portion 121Lb of the left-side face 121L of the fixing device 120 (i.e., faces the upper portion 121Lu), and thus the restriction of the displacement, inclination and the like of the fixing device 120 is loosened. Thus, the misalignment of the drawer connectors 123 and 133 due to the manufacturing error can be absorbed, and therefore the drawer connector 123 and the drawer connector 133 can appropriately engage with each other without being interrupted.

As described above, according to the image forming apparatus 100 of the second embodiment, the same effects as those of the image forming apparatus 1 of the first embodiment can be obtained.

### 3. THIRD EMBODIMENT

Next, the third embodiment will be described. The third embodiment is different from the first embodiment in a mechanism in which the fixing device 7 is attached to the apparatus main body 2. Hereinafter, description will be focused on differences from the first embodiment. An image forming apparatus, an apparatus main body and a fixing device of the third embodiment will be respectively referred to as an image forming apparatus 200, an apparatus main body 210 and a fixing device 220 in order to distinguish them from their correspondences in the first embodiment.

### 3-1. External Configuration of Fixing Device

FIG. 16 shows an external configuration of the fixing device 220 in the third embodiment. FIG. 16 is an external perspective view showing the fixing device 220 in a simplified manner as seen obliquely from the front right. The fixing device 220 has a fixing housing 221 as an enclosure. The fixing device 220 has a substantially rectangular parallelepiped shape elongated in the left-right direction.

As shown in FIG. 16, a positioning hole 222R and a positioning hole 222L are respectively provided in the vicinities of a right end and a left end of the fixing housing 221. Each of the positioning holes 222R and 222L penetrates from an upper face 221U to a bottom face 221B of the fixing housing 221. The positioning hole 222R has a substantially pillar shape elongated in the vertical direction. The positioning hole 222R includes a larger-diameter portion 222Ru which is located on the upper side, and a smaller-diameter portion 222Rb which is located below the larger-diameter portion 222Ru and whose diameter is smaller than the larger-diameter portion 222Ru. Moreover, a portion of the positioning hole 222R adjoining the smaller-diameter portion 222Rb has a tapered shape such that its diameter gradually decreases toward the smaller-diameter portion 222Rb. The positioning hole 222L has the same size and shape as those of the positioning hole 222R.

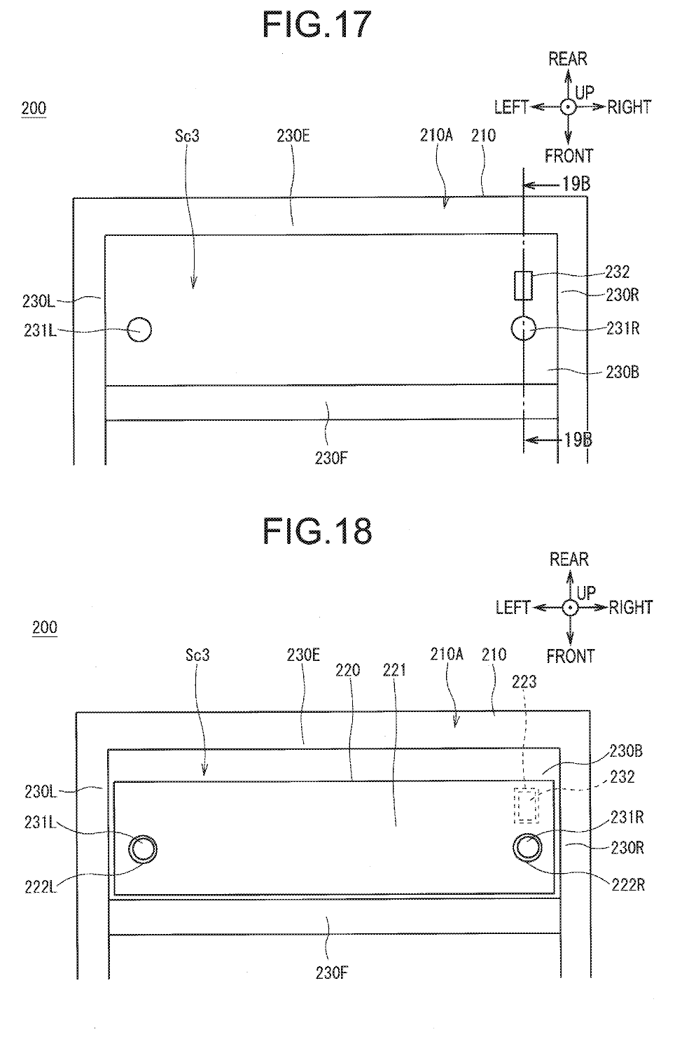

The positioning holes 222R and 222L are holes into which positioning posts 231R and 231L (see FIG. 17) provided in the apparatus main body 210 are respectively inserted when the fixing device 220 is attached to the apparatus main body 210.

Further, in the vicinity of a right end of the bottom face 221B of the fixing housing 221, a downward facing drawer connector 223 is formed on the rear side of the positioning hole 222R. The drawer connector 223 is a drawer connector similar to the drawer connector 22 of the first embodiment. When the fixing device 220 is attached to the apparatus main body 210, the drawer connector 223 engages with a drawer connector 232 provided in the apparatus main body 210.

### 3-2. External Configuration of Fixing Device Attachment Portion

FIGS. 17 and 18 show an external configuration of a fixing device attachment portion 210A provided in the apparatus main body 210 of the image forming apparatus 200. In this regard, FIGS. 17 and 18 are plan views showing the fixing device attachment portion 210A as seen from above. FIG. 17 shows the fixing device attachment portion 210A to which the fixing device 220 is not attached, and FIG. 18 shows the fixing device attachment portion 210A to which the fixing device 220 is attached.

As shown in FIGS. 17 and 18, the fixing device attachment portion 210A has a substantially box-shaped accommodation space Sc3 with its upper side opened. The accommodation space Sc3 is defined by a front frame 230F facing a front face 221F of the fixing housing 221 of the fixing device 220, a right-side frame 230R facing a right-side face 221R of the fixing housing 221, a left-side frame 230L facing a left-side face 221L of the fixing housing 221, a rear frame 230E facing a rear face of the fixing housing 221, and a bottom frame 230B facing a bottom face 221B of the fixing housing 221. In this regard, each of the frames 230F, 230R, 230L, 230E and 230B may be integrally formed or may be separately formed.

The accommodation space Sc3 is slightly larger than the fixing housing 221 of the fixing device 220. The accommodation space Sc3 has a size such that the fixing device 220 can be accommodated therein. The fixing device 220 is attached to the apparatus main body 210 of the image forming apparatus 200 by inserting the fixing device 220 into this accommodation space Sc3 provided in the fixing device attachment portion 210A.

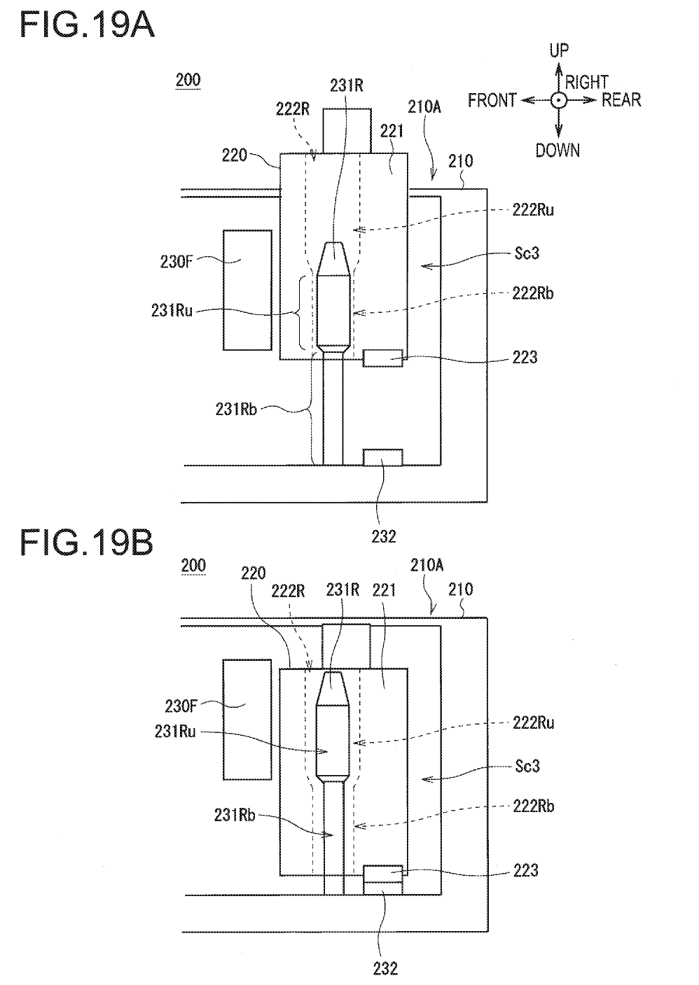

A positioning post 231R and a positioning post 231L are provided on the bottom frame 230B that forms the accommodation space Sc3. The positioning post 231R and the positioning post 231L both extend upward. The positioning post 231R and the positioning post 231L are respectively provided in the vicinity of the left end and in the vicinity of the right end of the bottom frame 230B. As shown in FIG. 19B, which is a sectional view cut along Line 19B-19B in FIG. 17, the positioning post 231R has a substantially columnar shape with a sharpened tip. The positioning post 231R has a length in the vertical direction substantially the same as the length of the positioning hole 222R of the fixing device 220 in the vertical direction. In this regard, FIG. 19B shows a state where the fixing device 220 is partway inserted into the accommodation space Sc3.

Moreover, the positioning post 231R has a larger-diameter portion 231Ru which is located on the upper side, and a smaller-diameter portion 231Rb which is located below the larger-diameter portion 231Ru and whose diameter is smaller than the larger-diameter portion 231Ru. Moreover, a portion of the positioning post 231R adjoining the smaller-diameter portion 231Rb has a tapered shape such that its diameter gradually decreases toward the smaller-diameter portion 231Rb. The diameter of the larger-diameter portion 231Ru (larger than the smaller-diameter portion 231Rb) of the positioning post 231R is slightly smaller than the smaller-diameter portion 222Rb of the positioning hole 222. The positioning hole 222L has the same size and shape as the positioning hole 222R.

When the fixing device 220 is attached to the apparatus main body 210, the positioning posts 231R and 231L are respectively inserted into the positioning holes 222R and 222L provided in the apparatus main body 210.

Further, as shown in FIG. 17, in the vicinity of the right end of the bottom frame 230B, the upward facing drawer connector 232 is formed on the rear side of the positioning post 231R. The drawer connector 232 is a drawer connector similar to the drawer connector 31 of the first embodiment. When the fixing device 220 is attached to the apparatus main body 210, the drawer connector 232 engages with the drawer connector 223 provided in the fixing device 220.

### 3-3. Attachment of Fixing Device

Next, the attachment of the fixing device 220 will be described with reference to FIGS. 19A and 19B. In this regard, the fixing device 220 is attached to the apparatus main body 210 in a state where the fixing device 220 is slightly inclined as in the first embodiment. However, for ease of explanation, the inclination of the fixing device 220 is omitted in FIGS. 19A and 19B.

When the fixing device 220 is attached to the apparatus main body 210, the fixing device 220 is inserted into the accommodation space Sc3 in such a manner that two positioning posts 231R and 231L provided in the apparatus main body 210 are respectively inserted into the two positioning holes 222R and 222L.

FIG. 19A shows a state where the fixing device 220 starts to be inserted into the accommodation space Sc3, and the larger-diameter portion 231Ru of the positioning post 231R is passing through the smaller-diameter portion 222Rb of the positioning hole 222R. At this stage, although not shown in FIG. 19A, a larger-diameter portion of the positioning post 231L is passing through a smaller-diameter portion of the positioning hole 222L similarly.

At this time, there is only a small gap between the larger-diameter portion 231Ru of the positioning post 231R and the smaller-diameter portion 222Rb of the positioning hole 222R. Similarly, there is only a small gap between the larger-diameter portion of the positioning post 231L and the smaller diameter portion of the positioning hole 222L. Therefore, the movement and inclination of the fixing device 220 in the front-rear direction and left-right direction are restricted.

Then, when the fixing device 220 is further inserted, as shown in FIG. 19B, the lower end of the drawer connector 223 and the upper end of the drawer connector 232 start to engage with each other.

At this stage, the whole of the larger-diameter portion 231Ru of the positioning post 231R has passed through the smaller-diameter portion 222Rb of the positioning hole 222R to reach the larger-diameter portion 222Ru, and the smaller-diameter portion 231Rb of the positioning post 231R is passing through the smaller-diameter portion 222Rb of the positioning hole 222R. Moreover, although not shown in FIG. 19B, the whole of the larger-diameter portion of the positioning post 231L passes through the smaller-diameter portion of the positioning hole 222L to reach the larger-diameter portion of the positioning hole 222L, and the smaller-diameter portion of the positioning post 231L is passing through the smaller-diameter portion of the positioning hole 222L.

At this stage, the gap between the positioning post 231R and the positioning hole 222R increases, and similarly the gap between the positioning post 231L and the positioning hole 222L also increases. Thus, the restriction of the movement and inclination of the fixing device 220 in the front-rear direction and the left-right direction is loosened.

Consequently, in the image forming apparatus 200, until the drawer connector 223 and the drawer connector 232 start to engage with each other, the displacement, inclination and the like of the fixing device 220 are restricted, so that the drawer connector 223 can be accurately guided to the drawer connector 232. After the drawer connector 223 and the drawer connector 232 start to engage with each other, the restriction of the displacement, inclination and the like of the fixing device 220 is loosened, so that the misalignment of the drawer connectors 223 and 232 due to the manufacturing error can be absorbed and the drawer connector 223 can appropriately engage with each other without being interrupted.

Thereafter, when the fixing device 220 is inserted into the accommodation space Sc3, the fixing device 220 is accommodated in the accommodation space Sc3, and the drawer connector 223 and the drawer connector 232 engage with each other so that the terminals thereof are electrically connected to each other. In this way, the attachment of the fixing device 220 to the apparatus main body 210 is completed.

### 3-4. Conclusion and Effects

As described above, according to the third embodiment, the apparatus main body 210 serving as an electronic apparatus includes the apparatus main body 210 and the fixing device 220 serving as an attachment-detachment device and being attachable to and detachable from the apparatus main body 210.

Further, the fixing device 220 includes the drawer connector 223 serving as a second connector. When the fixing device 220 is attached to the apparatus main body 210, the drawer connector 223 approaches the drawer connector 232 serving as a first connector provided in the apparatus main body 210, engages with the drawer connector 232, and is connected to the drawer connector 223.

Further, the fixing device 220 has the positioning hole 222R and the positioning hole 222L in the vicinities of the right end and the left end of the bottom face 221B. The positioning hole 222R and the positioning hole 222L are elongated toward the upper face 221U. When the fixing device 220 is attached to the apparatus main body 210, the positioning post 231R and the positioning post 231L are respectively inserted into the positioning hole 222R and the positioning hole 222L.

Further, each of the positioning posts 231R and 231L has a shape such that the lower portion is thinner than the upper portion. Similarly, each of the positioning holes 222R and 222L has a shape such that the lower portion is thinner than the upper portion.

During the attachment of the fixing device 220 to the apparatus main body 210, in a state where the drawer connector 232 and the drawer connector 223 do not engage with each other (see FIG. 19A), the thicker portions (larger-diameter portions) of the positioning posts 231R and 231L pass through the narrower portions (smaller-diameter portions) of the positioning holes 222R and 222L. After at least a part of the drawer connector 232 engages with at least a part of the drawer connector 223 (see FIG. 19B), the thicker portions (larger-diameter portions) of the positioning posts 231R and 231L pass through the thicker portions (larger-diameter portions) of the positioning holes 222R and 222L.

Consequently, in the image forming apparatus 200, during the attachment of the fixing device 220 to the apparatus main body 210, in a state where the drawer connector 223 and the drawer connector 232 are apart from each other, the thicker portions (larger-diameter portions) of the positioning posts 231R and 231L pass through the narrower portions (smaller-diameter portions) of the positioning holes 222R and 222L, so that the displacement, inclination and the like of the fixing device 220 can be restricted. Thus, the drawer connector 223 can be accurately guided to the drawer connector 232.

Further, in the image forming apparatus 200, after at least a part of the drawer connector 223 engages with at least a part of the drawer connector 232 (that is, after the drawer connector 223 and the drawer connector 232 start to engage with each other), the thicker portions (larger-diameter portions) of the positioning posts 231R and 231L pass through the thicker portions (larger-diameter portions) of the positioning holes 222R and 222L. Thus, the restriction of displacement, inclination and the like of the fixing device 220 is loosened, so that the misalignment of the drawer connectors due to the manufacturing error can be absorbed. Thus, the drawer connector 223 and the drawer connector 232 can appropriately engage with each other without being interrupted.

Consequently, according to the image forming apparatus 200 of the third embodiment, the same effects as those of the image forming apparatus 1 of the first embodiment can be obtained.

### 4. MODIFICATIONS

### 4-1. First Modification

In this regard, in the above-described first embodiment, the fixing device 7 includes the guide grooves 21F, 21R, and 21L, and the apparatus main body 2 includes the guide pins 30Fa, 30Fb, 30Ra, 30Rb, and 30L. However, the present disclosure is not limited to such a configuration. The fixing device 7 may include guide holes and the apparatus main body may include guide pins.

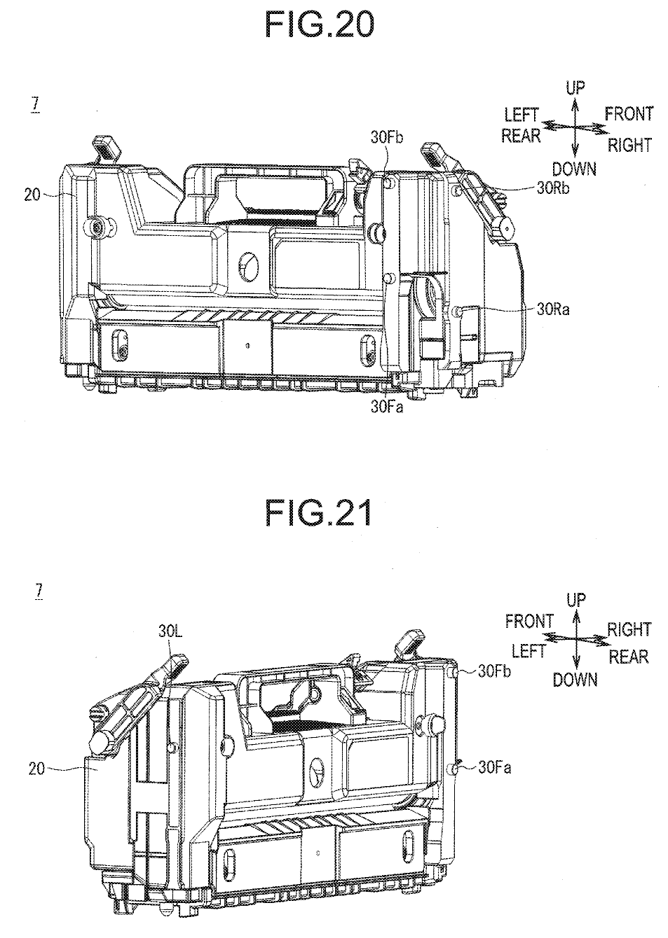

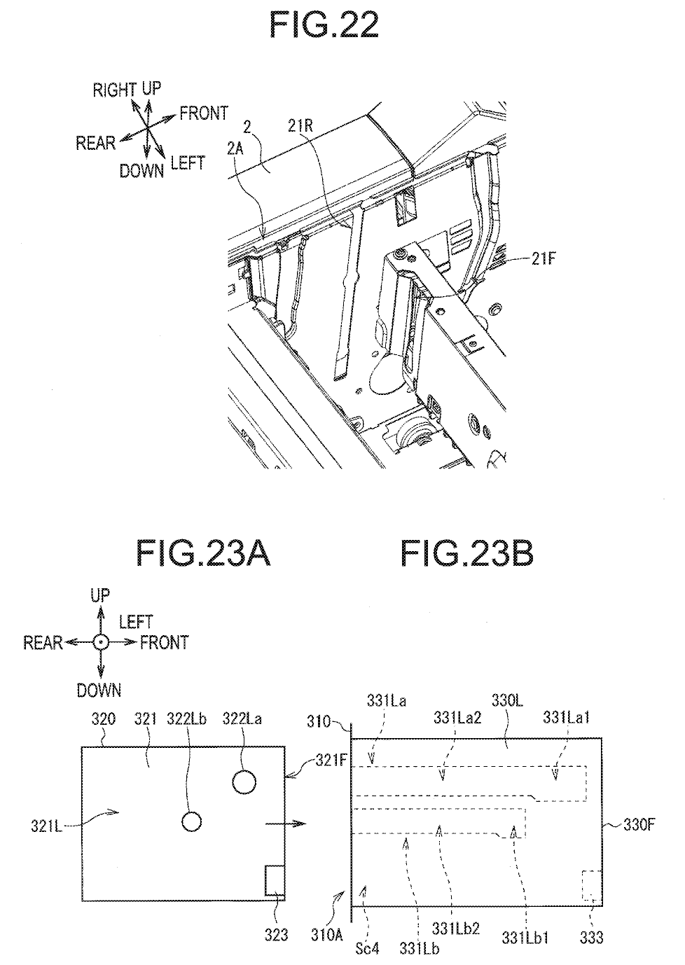

For example, as shown in FIG. 20 corresponding to FIG. 2, FIG. 21 corresponding to FIG. 3, and FIG. 22 which is a perspective view showing the right part of the fixing device attachment portion 2A as seen from above, the fixing device 7 may include the guide pins 30Fa, 30Fb, 30Ra, 30Rb and 30L, and the apparatus main body 2 may include the guide grooves 21F, 21R and 21L (the guide groove 21L is not shown). The same applies to the second embodiment.

### 4-2. Second Modification

The above-described first embodiment relates to the image forming apparatus 1 in which the fixing device 7 is inserted into the accommodation space Sc1 of the apparatus main body 2 from above. In other words, the attachment direction is a downward direction. However, the present disclosure is not limited to such a configuration. The image forming apparatus 1 may be configured so that the attachment direction is, for example, a lateral direction.

FIG. 23 shows an example of an image forming apparatus in which the attachment direction of a fixing device is a lateral direction. More specifically, FIG. 23 is a side view showing a fixing device attachment portion 310A provided in an apparatus main body 310, and a fixing device 320.

In a fixing housing 321 of the fixing device 320, a guide pin 322La is provided on an upper part in the vicinity of a front end of a left-side face 321L. A guide pin 322Lb is provided on the rear side of and below the guide pin 322La on the left-side face 321L (i.e., center part in the vertical direction and front-rear direction on the left-side face 321L). Further, a drawer connector 323 facing frontward is provided on, for example, a lower end of a front surface 321F of the fixing housing 321.

The fixing device attachment portion 310A has a substantially box-shaped accommodation space Sc4 with an upper side opened. Further, a guide groove 331La is formed on a left-side frame 330L forming the left side of accommodation space Sc4. The guide groove 331La extends in the front-rear direction from a rear end toward a front end of an upper part of the left-side frame 330L. Moreover, a guide groove 331Lb is formed on the left-side frame 330L. The guide groove 331Lb extends in the front-rear direction from a rear end of a center part in the vertical direction of the left-side frame 330L to a position slightly on the front side of a center part in the front-rear direction of the left-side frame 330L.

The guide groove 331La has a wider portion 331La1 at its front end and a narrower portion 331La2 located on the rear side of the wider portion 331La1. Similarly, the guide groove 331Lb has a wider portion 331Lb1 at its front end and a narrower portion 331Lb2 located on the rear side of the wider portion 331Lb1. A length of the wider portion 331La1 in the front-rear direction is longer than a length of the wider portion 331Lb1 in the front-rear direction. Further, a drawer connector 332 facing rearward is provided on a front frame 330F forming a front side of the accommodation space Sc4.

The fixing device 320 is attached to the apparatus main body 330 by inserting the fixing device 320 into the accommodation space Sc4 of the fixing device attachment portion 310A of the apparatus main body 310 through the rear side of the accommodation space Sc4.

During the attachment of the fixing device 320 to the apparatus main body 310, when the drawer connector 323 and the drawer connector 332 start to engage with each other, the upper guide pin 322La reaches the wider portion 331La1 in the upper guide groove 331La (while the lower guide pin 322Lb is still passing through the narrower portion 331Lb2), so that the restriction of the displacement, inclination and the like of the fixing device 320 is loosened. Thus, the misalignment of the drawer connectors 323 and 332 due to the manufacturing error is absorbed, and therefore the drawer connector 323 and the drawer connector 332 can appropriately engage with each other without being interrupted.

### 4-3. Third Modification

In the above-described first embodiment, two guide pins 30Fa and 30Fb are provided for the guide groove 21F, and two guide pins 30Ra and 30Rb are provided for the guide groove 21R. That is, a plurality of guide pins are inserted into each of the guide grooves.

However, the present disclosure is not limited to such a configuration. For example, the right-side face 20R of the fixing device 7 may be provided with two guide grooves with an interval in the front-rear direction, and the right-side frame 40R of the apparatus main body 2 may be provided with two guide pins, one for each of the two guide grooves. Same applies to the second embodiment.

### 4-4. Fourth Modification

In the above-described first embodiment, the drawer connectors 22 and 31 are used as connectors for connecting the fixing device 7 and the apparatus main body 2. However, the present disclosure is not limited to such a configuration. Connectors other than the drawer connectors may be used as long as the connectors gradually engage with each other during the attachment of the fixing device 7 to the apparatus main body 2. Same applies to the second and third embodiments.

Further, in the above-described first embodiment, the drawer connector 31 is movable with respect to the apparatus main body 2 within a predetermined range. However, the present disclosure is not limited to such a configuration. The drawer connector 31 may be fixed to the apparatus main body 2, and the drawer connector 22 may be movable with respect to the fixing device 7 within a predetermine range. Same applies to the second and third embodiments.

### 4-5. Fifth Modification

In the above-described first embodiment, the guide grooves 21F, 21R and 21L are respectively provided on the front face 20F, the right-side face 20R and the left-side face 20L of the fixing device 7. However, the present disclosure is not limited to such a configuration. It is sufficient that at least one guide groove is provided on at least one end of the fixing device 7 in a direction (for example, front-rear direction or left-right direction) perpendicular to the attachment direction. In this case, it is sufficient that the apparatus main body 2 includes at least one guide pin at a position so that the guide pin is insertable into the guide groove. Same applies to the second embodiment.

### 4-6. Sixth Modification

The above-described embodiments relate to the image forming apparatuses 1, 100, and 200 as monochrome printers including the attachable and detachable fixing devices 7, 120 and 220. However, the present disclosure is not limited to such examples. The present disclosure is applicable to various image forming apparatuses such as a color printer, a copying machine, a facsimile machine, and a MFT (Multi-Function Peripheral: combined machine) including the attachable and detachable fixing device. Further, the present disclosure is applicable to various types of electronic apparatuses including an attachment-detachment device which is attachable to and detachable from an apparatus main body.

The above-described embodiments relate to the fixing devices 7, 120, and 220 which are attachable to and detachable from the apparatus main bodies 2, 110, and 210. However, the present disclosure is applicable to various types of attachment-detachment devices which are attachable to and detachable from the apparatus main bodies. For example, the present disclosure is applicable to attachable and detachable consumables with electrical connection such as a developer cartridge, an additional cassette or the like. The present disclosure is not only applicable to image forming apparatuses, but also applicable to apparatuses including attachable and detachable consumables with electrical connection (as with a developer cartridge, an additional cassette or the like).

### 4-7. Seventh Modification

The present disclosure is not limited to the above-described embodiments and modifications. That is, various modifications or changes can be made to these embodiments and modifications. The respective embodiments and modifications may be combined as appropriate.[5. Appendix es ]

### 5. Appendixes

Various aspects of the present disclosure are collectively described below as appendixes.

### 5-1. Appendix 1

An electronic apparatus comprising:

an apparatus main body;

an attachment-detachment device which is attachable to and detachable from the apparatus main body;

a first engagement portion provided on at least one end side of both end sides of one of the apparatus main body and the attachment-detachment device in a crossing direction crossing an attachment direction; and

a first to-be-engaged portion provided in the other of the apparatus main body and the attachment-detachment device, the first to-be-engaged portion being engageable with the first engagement portion,

wherein the attachment-detachment device includes a second connector which is connectable with the first connector of the apparatus main body by approaching and engaging with the first connector during an attachment of the attachment-detachment device to the apparatus main body;

wherein the first to-be-engaged portion includes:

a first region through which the first engagement portion passes in a state where the first connector and the second connector do not engage with each other and are apart from each other during the attachment of the attachment-detachment device to the apparatus main body, and

a second region through which the first engagement portion passes after at least a part of the first connector and at least a part of the second connector engage with each other during the attachment of the attachment-detachment device to the apparatus main body, and

wherein a movable range of the first engagement portion with respect to the first to-be-engaged portion in the crossing direction is larger when the first engagement portion passes through the second region than when the first engagement portion passes through the first region.

### 5-2. Appendix 2

The electronic apparatus according to appendix 1, wherein the first engagement portion is a first projecting portion,

wherein the first to-be-engaged portion is a first groove guiding the first projecting portion, and

wherein in the first groove, a width of the second region in the crossing direction is wider than a width of the first region in the crossing direction.

### 5-3. Appendix 3

The electronic apparatus according to appendix 1 or 2, wherein a plurality of engagement portions are provided on both end sides of the one of the apparatus main body and the attachment-detachment device in a longitudinal direction of the attachment-detachment device crossing the attachment direction;

wherein the other of the apparatus main body and the attachment-detachment device includes a plurality of to-be-engaged portions which are engageable with the plurality of engagement portions;

wherein the first engagement portion is one of the plurality of engagement portions;

wherein the first to-be-engaged portion is one of the plurality of to-be-engaged portions; and

wherein the first engagement portion is provided on the same end side as the first connector of both end sides of the one of the apparatus main body and the attachment-detachment device in the longitudinal direction.

### 5-4. Appendix 4

The electronic apparatus according to any one of appendixes 1 to 3, wherein a plurality of engagement portions are provided on the one end side of the one of the apparatus main body and the attachment-detachment device;

wherein the first to-be-engaged portion is provided in the other of the apparatus main body and the attachment-detachment device, and is engageable with the plurality of engagement portions;

wherein the first engagement portion is one of the plurality of engagement portions; and

wherein the first engagement portion is provided on the most upstream side among the plurality of the engagement portions.

### 5-5. Appendix 5

The electronic apparatus according to appendix 4, wherein the plurality of engagement portions include a second engagement portion located on a downstream side of the first engagement portion in the attachment direction;

wherein the first to-be-engaged portion includes a third region through which the second engagement portion passes when the first engagement portion passes through the second region; and

wherein a movable range of the first engagement portion with respect to the first to-be-engaged portion in the crossing direction when the second engagement portion passes through the third region is narrower than a movable range of the first engagement portion with respect to the first to-be-engaged portion in the crossing direction when the first engagement portion passes through the second region.

### 5-6. Appendix 6

The electronic apparatus according to appendix 5, further comprising a positioning engagement portion provided in one of the apparatus main body and the attachment-detachment device;

a positioning to-be-engaged portion provided in the other of the apparatus main body and the attachment-detachment device, the positioning to-be-engaged portion being engageable with the positioning engagement portion;

wherein during the attachment of the attachment-detachment device to the apparatus main body, the positioning engagement portion and the positioning to-be-engaged portion approach each other to engage with each other; and

wherein the second engagement portion passes through the third region until the positioning engagement portion and the positioning to-be-engaged portion engage with each other.

### 5-7. Appendix 7

The electronic apparatus according to any one of appendixes 1 to 6, wherein the first connector is supported so as to be movable in a predetermined range with respect to the apparatus main body.

### 5-8. Appendix 8

An image forming apparatus comprising the electronic apparatus according to any one of appendixes 1 to 7,

wherein the attachment-detachment device is a fixing device.

### 5-9. Appendix 9

An attachment-detachment device which is attachable to and detachable from an apparatus main body,

the attachment-detachment device comprising:

a first to-be-engaged portion provided on at least one end side of both end sides of the attachment-detachment device in a crossing direction crossing an attachment direction, the first to-be-engaged portion being engageable with a first engagement portion provided in the apparatus main body; and

a second connector which is connectable with the first connector of the apparatus main body by approaching and engaging with the first connector during an attachment of the attachment-detachment device to the apparatus main body;

wherein the first to-be-engaged portion includes:

a first region through which the first engagement portion passes in a state where the first connector and the second connector do not engage with each other and are apart from each other during the attachment of the attachment-detachment device to the apparatus main body, and

a second region through which the first engagement portion passes after at least a part of the first connector and at least a part of the second connector engage with each other during the attachment of the attachment-detachment device to the apparatus main body, and

wherein a movable range of the first engagement portion with respect to the first to-be-engaged portion in the crossing direction is larger when the first engagement portion passes through the second region than when the first engagement portion passes through the first region.

### 5-10. Appendix 10

An attachment-detachment device which is attachable to and detachable from an apparatus main body,

the attachment-detachment device comprising:

a second connector which is connectable with the first connector of the apparatus main body by approaching and engaging with the first connector during an attachment of the attachment-detachment device to the apparatus main body; and

a guide portion extending in an attachment direction of the attachment-detachment device and guiding the attachment-detachment device which is attached,

wherein the guide portion has a first area, a second area, a third area and a fourth area which are arranged in this order from an upstream side in the attachment direction,

wherein in a crossing direction crossing the attachment direction, a width of the first area is wider than a width of the second area, and a width of the third area is wider than a width of the fourth area.

### 5-11. Appendix 11

The attachment-detachment device according to appendix 10, wherein the guide portion is provided on the same end side as the second connector of both end sides of the attachment-detachment device in a longitudinal direction of the attachment-detachment device crossing the attachment direction, and

wherein in the attachment direction, a length of the third area is narrower than a length of the first area.

### 5-12. Appendix 12

A fixing device comprising the attachment-detachment device according to appendix 10 or 11,

wherein the fixing device includes a heating portion, and a pressurizing portion.

The present disclosure is applicable to, for example, an image forming apparatus including an attachable and detachable fixing device.

### DESCRIPTION OF REFERENCE CHARACTERS

1: image forming apparatus, 2: apparatus main body, 2A: fixing device attachment portion, 7: fixing device, 20: fixing housing, 21F: guide groove, 21Fa, 21Fb: wider portion, 21Fc, 21Fd: narrower portion, 21L: guide groove, 21La, 21Lb: narrower portion, 21R: guide groove, 21Ra, 21Rb: wider portion, 21Rc, 21Rd: narrower portion, 22, 31: drawer connector, 23: positioning hole, 30Fa, 30Fb, 30L, 30Ra, 30Rb: guide pin, 32: positioning post, 100: image forming apparatus, 110: apparatus main body, 110A: fixing device attachment portion, 120: fixing device, 121: fixing housing, 122Ra, 122Rb: guide pin, 123, 133: drawer connector, 131: guide groove, 132: pressing portion, 200: image forming apparatus, 210: apparatus main body, 210A: fixing device attachment portion, 220: fixing device, 221: fixing housing, 223, 232: drawer connector, 231L, 231R: positioning post, 231Rb: smaller-diameter portion, 231Ru: larger-diameter portion, 310: apparatus main body, 310A: fixing device attachment portion, 320: fixing device, 321: fixing housing, 322La, 322Lb: wider portion, 331La2: narrower portion, 331Lb: guide groove, 331Lb1: wider portion, 331Lb2: narrower portion.

What is claimed is:

1. An electronic apparatus comprising:
an apparatus main body having a first connector;
an attachment-detachment device which is attachable to and detachable from the apparatus main body;
a first engagement portion provided on at least one end side of both end sides of one of the apparatus main body and the attachment-detachment device in a crossing direction crossing an attachment direction; and
a first to-be-engaged portion provided in the other of the apparatus main body and the attachment-detachment device, the first to-be-engaged portion being engageable with the first engagement portion,
wherein the attachment-detachment device includes a second connector which is connectable with the first connector of the apparatus main body by approaching and engaging with the first connector during an attachment of the attachment-detachment device to the apparatus main body;
wherein the first to-be-engaged portion includes:
a first region through which the first engagement portion passes in a state where the first connector and the second connector do not engage with each other and are apart from each other during the attachment of the attachment-detachment device to the apparatus main body, and
a second region through which the first engagement portion passes after at least a part of the first connector and at least a part of the second connector engage with each other during the attachment of the attachment-detachment device to the apparatus main body, and
wherein a movable range of the first engagement portion with respect to the first to-be-engaged portion in the crossing direction is larger when the first engagement portion passes through the second region than when the first engagement portion passes through the first region.

2. The electronic apparatus according to claim 1, wherein the first engagement portion is a first projecting portion,
wherein the first to-be-engaged portion is a first groove guiding the first projecting portion, and
wherein in the first groove, a width of the second region in the crossing direction is wider than a width of the first region in the crossing direction.

3. The electronic apparatus according to claim 1, wherein a plurality of engagement portions are provided on both end sides of the one of the apparatus main body and the attachment-detachment device in a longitudinal direction of the attachment-detachment device crossing the attachment direction;
wherein the other of the apparatus main body and the attachment-detachment device includes a plurality of to-be-engaged portions which are engageable with the plurality of engagement portions;
wherein the first engagement portion is one of the plurality of engagement portions;
wherein the first to-be-engaged portion is one of the plurality of to-be-engaged portions; and
wherein the first engagement portion is provided on the same end side as the first connector of both end sides of the one of the apparatus main body and the attachment-detachment device in the longitudinal direction.

4. The electronic apparatus according to claim 1, wherein a plurality of engagement portions are provided on the one end side of the one of the apparatus main body and the attachment-detachment device;
wherein the first to-be-engaged portion is provided in the other of the apparatus main body and the attachment-detachment device, and is engageable with the plurality of engagement portions;
wherein the first engagement portion is one of the plurality of engagement portions; and
wherein the first engagement portion is provided on the most upstream side among the plurality of the engagement portions.

5. The electronic apparatus according to claim 4, wherein the plurality of engagement portions include a second engagement portion located on a downstream side of the first engagement portion in the attachment direction;
wherein the first to-be-engaged portion includes a third region through which the second engagement portion passes when the first engagement portion passes through the second region; and
wherein a movable range of the first engagement portion with respect to the first to-be-engaged portion in the crossing direction when the second engagement portion passes through the third region is narrower than a movable range of the first engagement portion with respect to the first to-be-engaged portion in the crossing direction when the first engagement portion passes through the second region.

6. The electronic apparatus according to claim 5, further comprising a positioning engagement portion provided in one of the apparatus main body and the attachment-detachment device;
a positioning to-be-engaged portion provided in the other of the apparatus main body and the attachment-detachment device, the positioning to-be-engaged portion being engageable with the positioning engagement portion;
wherein during the attachment of the attachment-detachment device to the apparatus main body, the positioning engagement portion and the positioning to-be-engaged portion approach each other to engage with each other; and
wherein the second engagement portion passes through the third region until the positioning engagement portion and the positioning to-be-engaged portion engage with each other.

7. The electronic apparatus according to claim 1, wherein the first connector is supported so as to be movable in a predetermined range with respect to the apparatus main body.

8. An image forming apparatus comprising the electronic apparatus according to claim 1,
wherein the attachment-detachment device is a fixing device.

9. An attachment-detachment device which is attachable to and detachable from an apparatus main body having a first connector,
the attachment-detachment device comprising:
a first to-be-engaged portion provided on at least one end side of both end sides of the attachment-detachment device in a crossing direction crossing an attachment direction, the first to-be-engaged portion being engageable with a first engagement portion provided in the apparatus main body; and
a second connector which is connectable with the first connector of the apparatus main body by approaching and engaging with the first connector during an attachment of the attachment-detachment device to the apparatus main body;
wherein the first to-be-engaged portion includes:
a first region through which the first engagement portion passes in a state where the first connector and the second connector do not engage with each other and are apart from each other during the attachment of the attachment-detachment device to the apparatus main body, and
a second region through which the first engagement portion passes after at least a part of the first connector and at least a part of the second connector engage with each other during the attachment of the attachment-detachment device to the apparatus main body, and
wherein a movable range of the first engagement portion with respect to the first to-be-engaged portion in the crossing direction is larger when the first engagement portion passes through the second region than when the first engagement portion passes through the first region.

10. An attachment-detachment device which is attachable to and detachable from an apparatus main body having a first connector,
the attachment-detachment device comprising:
a second connector which is connectable with the first connector of the apparatus main body by approaching and engaging with the first connector during an attachment of the attachment-detachment device to the apparatus main body; and
a guide portion extending in an attachment direction of the attachment-detachment device and guiding the attachment-detachment device which is attached,
wherein the guide portion has a first area, a second area, a third area and a fourth area which are arranged in this order from an upstream side in the attachment direction, and
wherein in a crossing direction crossing the attachment direction, a width of the first area is wider than a width of the second area, and a width of the third area is wider than a width of the fourth area.

11. The attachment-detachment device according to claim 10, wherein the guide portion is provided on the same end side as the second connector of both end sides of the attachment-detachment device in a longitudinal direction of the attachment-detachment device crossing the attachment direction, and
wherein in the attachment direction, a length of the third area is narrower than a length of the first area.

12. A fixing device comprising the attachment-detachment device according to claim 10,
wherein the fixing device includes a heating portion, and a pressurizing portion.
